(19) United States
(12) Patent Application Publication
(10) Pub. No.: US 2024/0394116 A1
(43) Pub. Date: Nov. 28, 2024

(54) METHOD AND SYSTEM THAT EFFICIENTLY ALLOCATE AND PROVISION VIRTUAL-NETWORKS DURING CLOUD-TEMPLATE-DIRECTED CLOUD-INFRASTRUCTURE DEPLOYMENT

(71) Applicant: VMware LLC, Palo Alto, CA (US)

(72) Inventors: KALYAN DEVARAKONDA, Bangalore (IN); Aditi Srinivas, Bangalore (IN); Valentina Leonidovna Reutova, London (GB); Suchitha Shet, Banalore (IN)

(21) Appl. No.: 18/227,308

(22) Filed: Jul. 28, 2023

(30) Foreign Application Priority Data
May 26, 2023 (IN) 202341036580

(51) Int. Cl. G06F 9/50; G06F 9/455

(52) U.S. Cl. CPC G06F 9/5077; G06F 9/45558; G06F 2009/45595

(57) ABSTRACT

The current document is directed to improved methods and improved cloud-infrastructure deployment systems that efficiently allocate and provision virtual networks during cloud-template-directed cloud-infrastructure deployment. The improved cloud-infrastructure deployment systems provide higher-granularity cloud-template specifications of virtual networks as well as the assignment of a priority to each project with respect to which cloud-infrastructure is deployed. The improved methods provide for concurrent cloud-infrastructure deployments, prioritization of concurrent cloud-infrastructure deployments, and reservation of networks based on network-resource specifications of increased granularity prior to allocation and provisioning of network resources.

### RELATED APPLICATIONS

Benefit is claimed under 35 U.S.C. 119 (a)-(d) to Foreign application No. 202341036580 filed in India entitled “METHOD AND SYSTEM THAT EFFICIENTLY ALLOCATE AND PROVISION VIRTUAL-NETWORKS DURING CLOUD-TEMPLATE-DIRECTED CLOUD-INFRASTRUCTURE DEPLOYMENT”, on May 26, 2023, by VMware, Inc., which is herein incorporated in its entirety by reference for all purposes.

### TECHNICAL FIELD

The current document is directed to distributed-computer-systems and, in particular, to methods and cloud-infrastructure deployment systems that efficiently allocate and provision virtual networks during cloud-template-directed cloud-infrastructure deployment.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems, distributed applications, and distributed services has increased, the management and administration of distributed computing systems and distributed applications and services hosted by distributed computing systems has, in turn, become increasingly complex, involving greater computational overheads and significant inefficiencies and deficiencies. In fact, many desired management-and-administration functionalities are becoming sufficiently complex to render traditional manual approaches to management and administration of distributed computing systems impractical, from a time and cost standpoint, and even from a feasibility standpoint. Therefore, designers and developers are seeking to implement and improve semi-automated and automated management-and-administration facilities and functionalities.

### SUMMARY

The current document is directed to improved methods and improved cloud-infrastructure deployment systems that efficiently allocate and provision virtual networks during cloud-template-directed cloud-infrastructure deployment. The improved cloud-infrastructure deployment systems provide higher-granularity cloud-template specifications of virtual networks as well as the assignment of a priority to each project with respect to which cloud-infrastructure is deployed. The improved methods provide for concurrent cloud-infrastructure deployments, prioritization of concurrent cloud-infrastructure deployments, and reservation of networks based on network-resource specifications of increased granularity prior to allocation and provisioning of network resources.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate several types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a wide-area network through which a number of processor-controlled devices communicate.

FIG. 9 illustrates private network addresses.

FIG. 10 illustrates the concept of subnetworks or subnets.

FIG. 11 illustrates the Open Systems Interconnection model (“OSI model”) that characterizes many modern approaches to implementation of communications systems that interconnect computers.

FIGS. 12A-B illustrate a layer-2-over-layer-3 encapsulation technology on which virtualized networking can be based.

FIG. 13 illustrates virtualization of two communicating servers.

FIG. 14 illustrates a virtual distributed computer system based on one or more distributed computer systems.

FIG. 15 illustrates components of several implementations of a virtual network within a distributed computing system.

FIG. 16 illustrates a number of different cloud-computing facilities that provide computational infrastructure to an organization for supporting the organization's distributed applications and services.

FIG. 17 illustrates a universal-management-interface provided by a comprehensive cloud-infrastructure-management service.

FIG. 18 illustrates one implementation of a comprehensive cloud-infrastructure-management service.

FIG. 19 illustrates the architecture of a second comprehensive cloud-infrastructure-management system that aggregates the functionalities of multiple cloud-provider distributed management systems and other management systems, including distributed-application management systems, to provide a consistent, uniform view of multiple cloud-computing systems and a single management interface to users.

FIG. 20 shows cloud-account, cloud-zone, and project data structures along with a cloud template.

FIG. 21 illustrates relationships between cloud-providers, cloud-provider regions, cloud-zone data structures, project data structures, and cloud templates.

FIG. 22 illustrates a network-profile data structure.

FIG. 23 illustrates a cloud template.

FIGS. 24-25 illustrate several new features added to the project data structure and the network-profile data structure.

FIGS. 26A-B provide control-flow diagrams for a cloud-infrastructure deployment method that provides an example of current cloud-infrastructure deployment in currently available cloud-infrastructure-management systems.

FIGS. 27A-D provide control-flow diagrams that illustrate the currently disclosed improved cloud-infrastructure deployment method incorporated within improved cloud-infrastructure-management systems.

### DETAILED DESCRIPTION

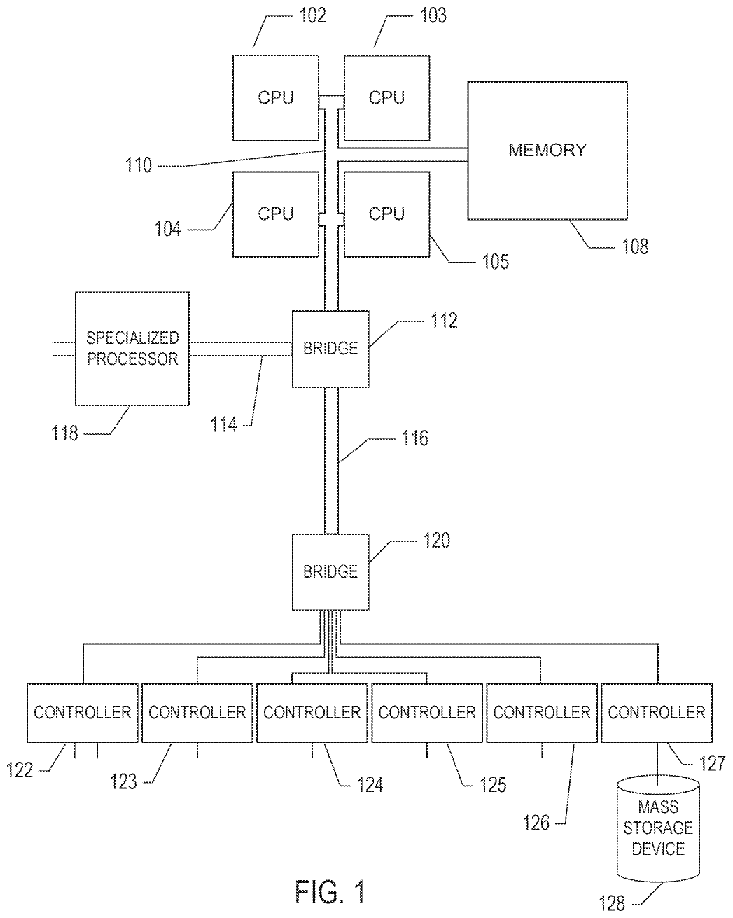

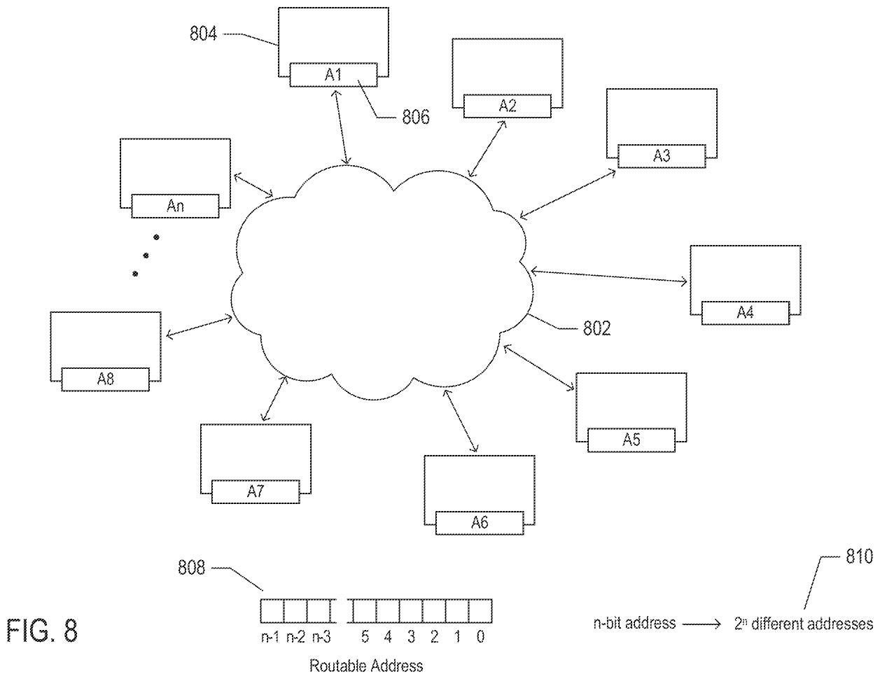

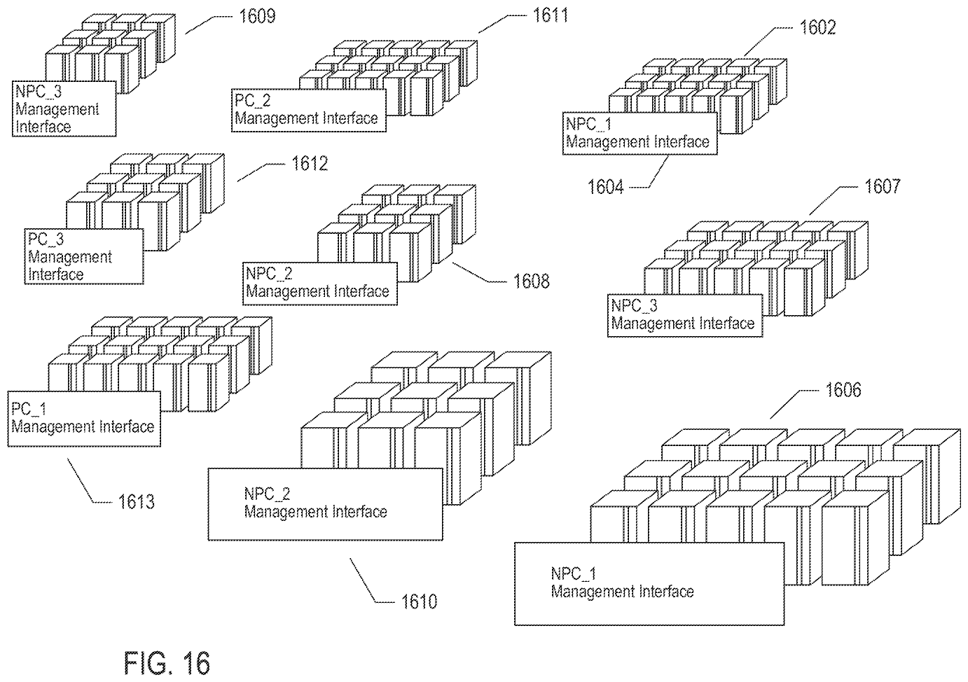

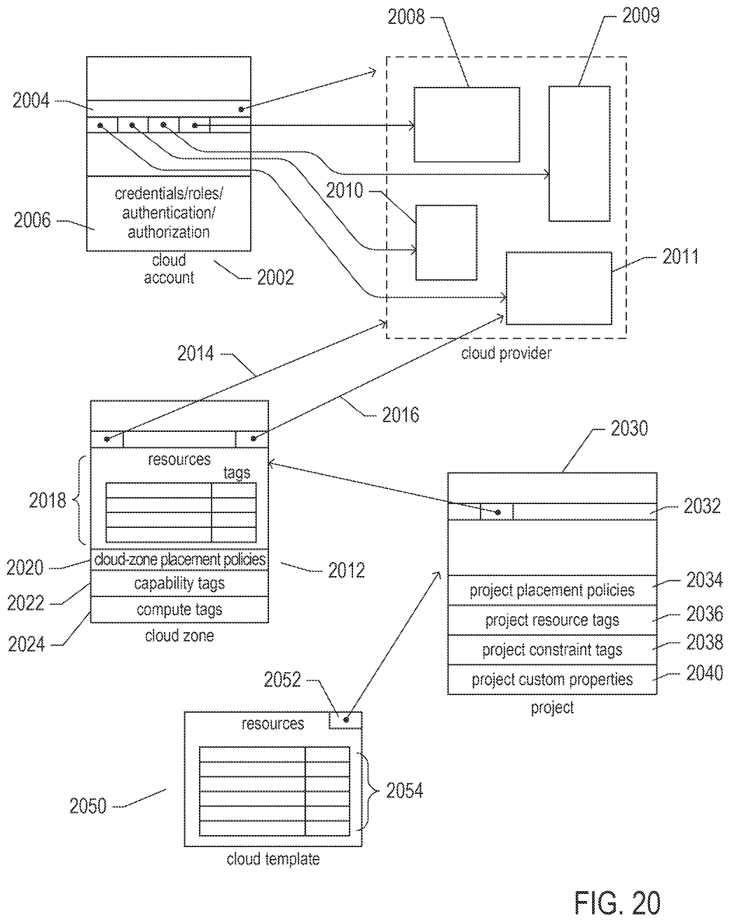

The current document is directed to improved methods and improved cloud-infrastructure deployment systems that efficiently allocate and provision virtual networks during cloud-template-directed cloud-infrastructure deployment. In a first subsection, below, a detailed description of computer hardware, complex computational systems, and virtualization is provided with reference to FIGS. 1-7. A second subsection provides an overview of network addresses, subnets, and virtual networks with reference to FIGS. 8-15. A third subsection provides an overview of cloud-infrastructure management systems with reference to FIGS. 16-19. In a fourth subsection, the currently disclosed methods and systems are discussed with reference to FIGS. 20-27D.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

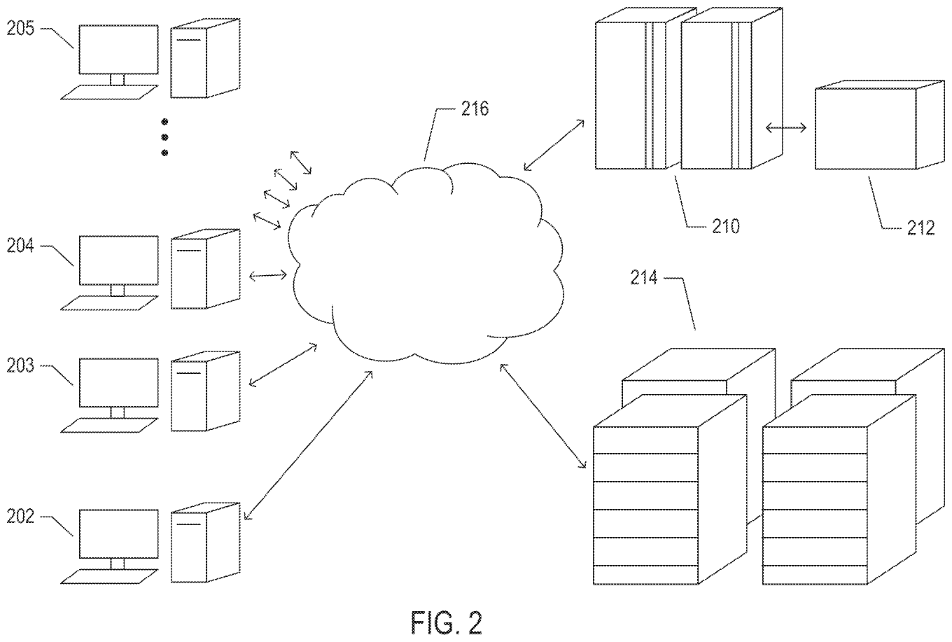

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

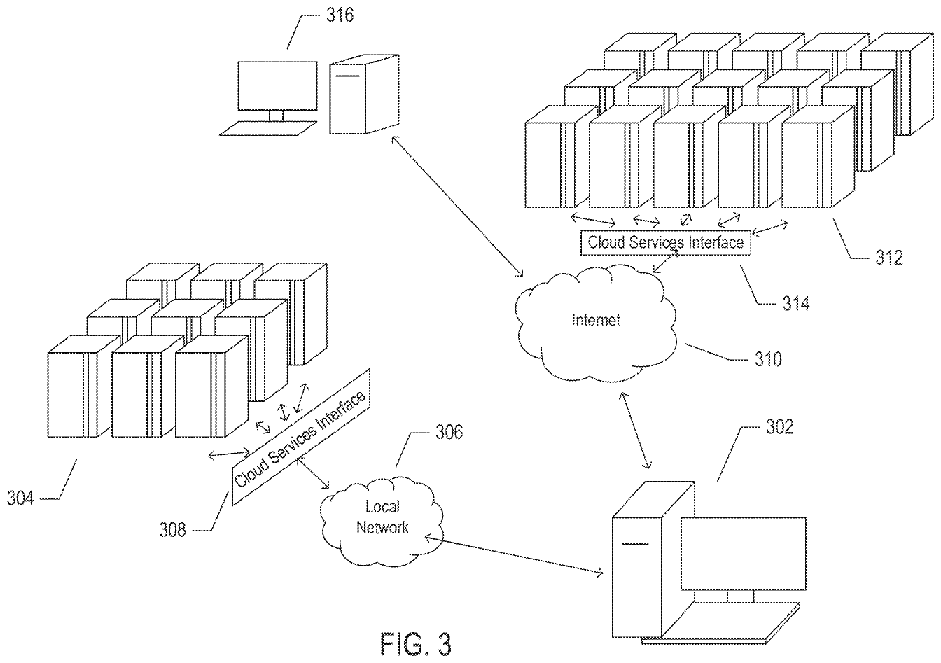

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

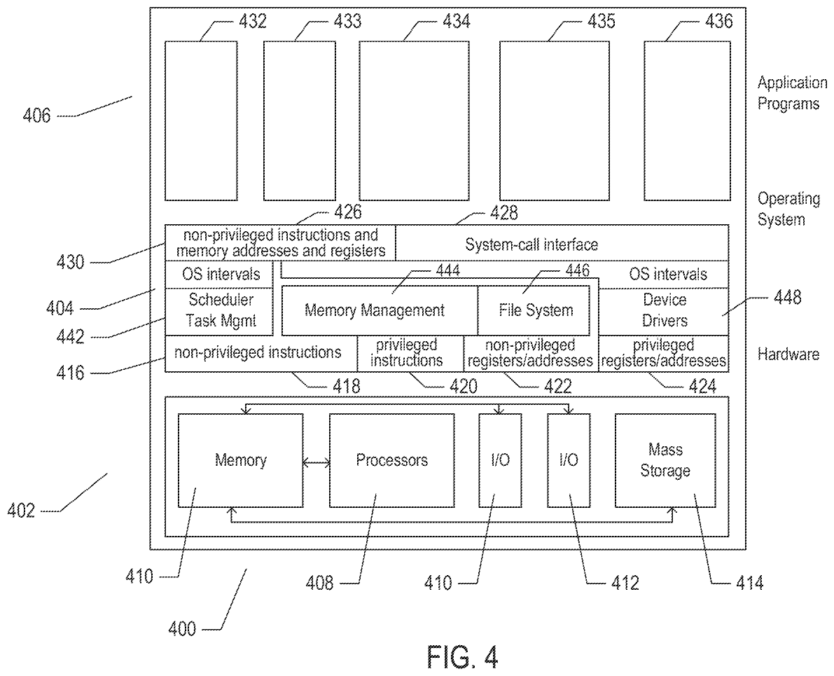

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

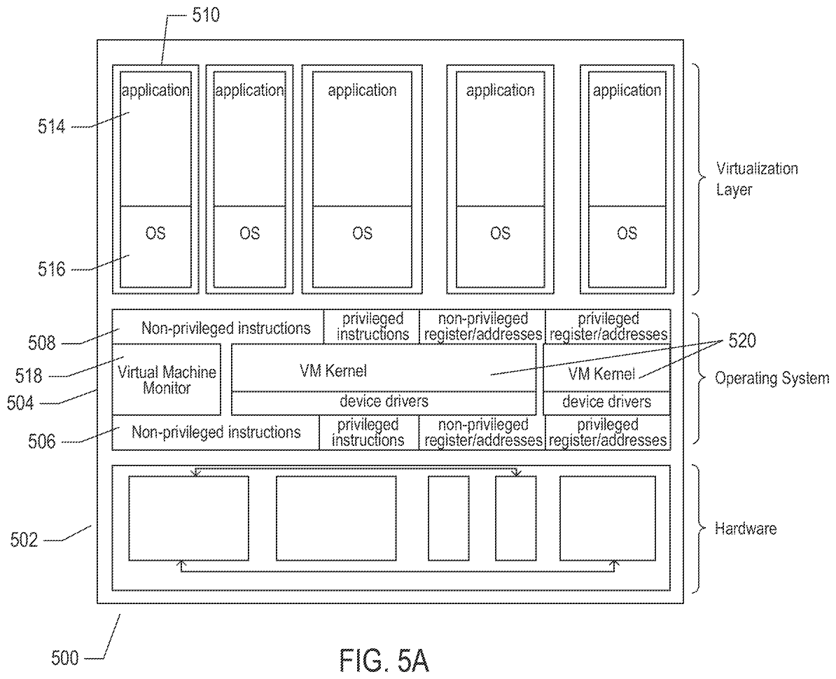

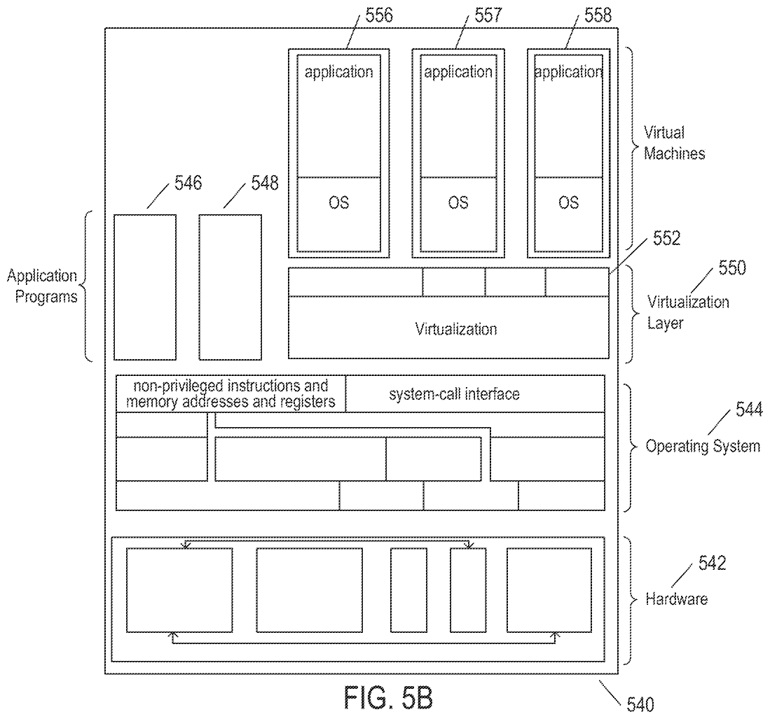

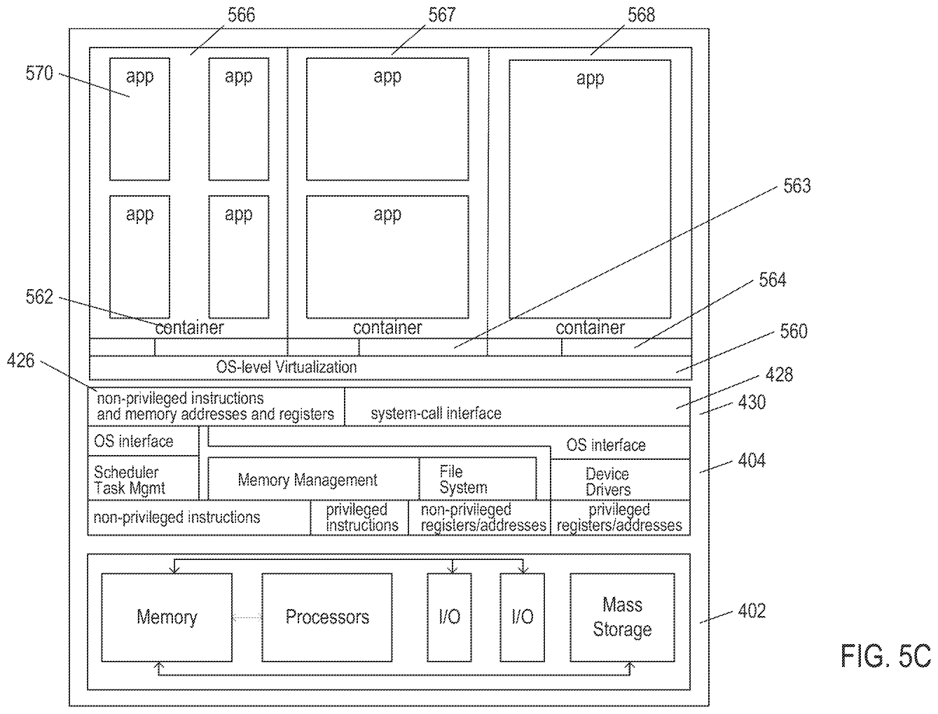

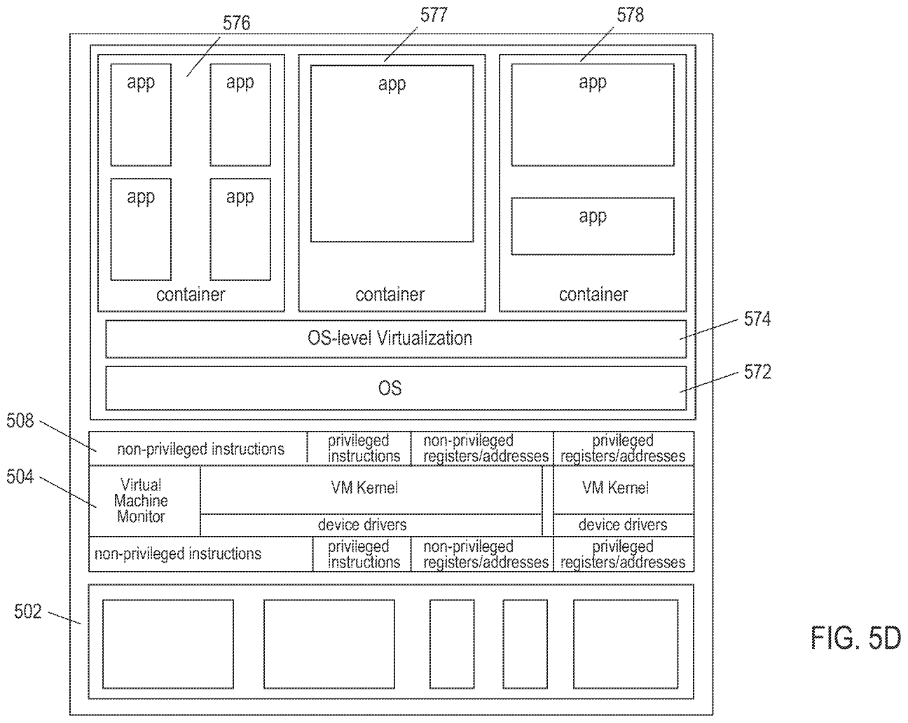

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

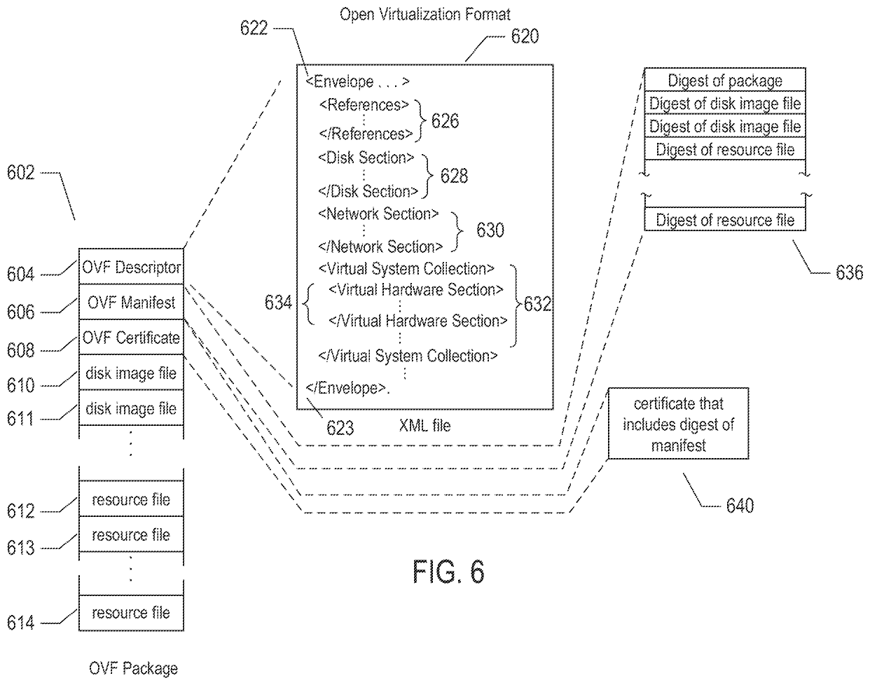

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

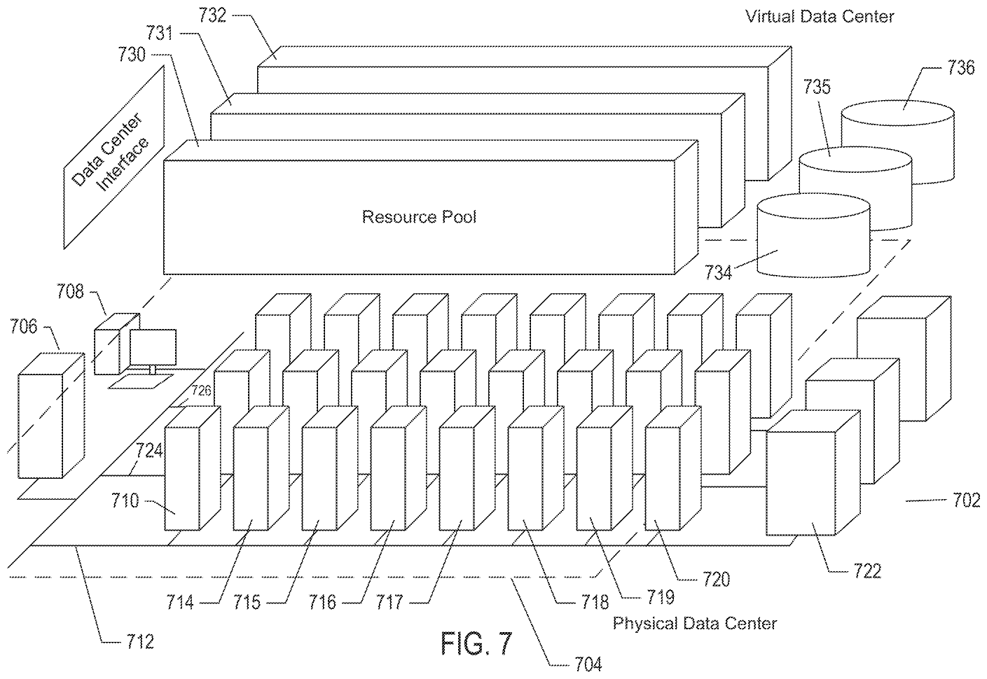

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Network Addresses, Subnets, and Virtual Networks

FIG. 8 illustrates a wide-area network (“WAN”) 802 through which a number of processor-controlled devices, such as processor-controlled device 804, communicate. Each processor-controlled device includes a network address, such as network address 806 associated with processor-controlled device 804. Each processor-controlled device that communicates with other processor-controlled devices through the network has a unique network address so that messages directed to a particular processor-controlled device can be correctly routed to that device. This set of unique addresses can be referred to as a “routable-address space.” When each routable address comprises n bits 808, there are 2ⁿ different possible routable addresses 810. In many cases, certain of the possible routable addresses are reserved for various special purposes, but the number of routable addresses is equal to 2ⁿ-C, where C is a constant.

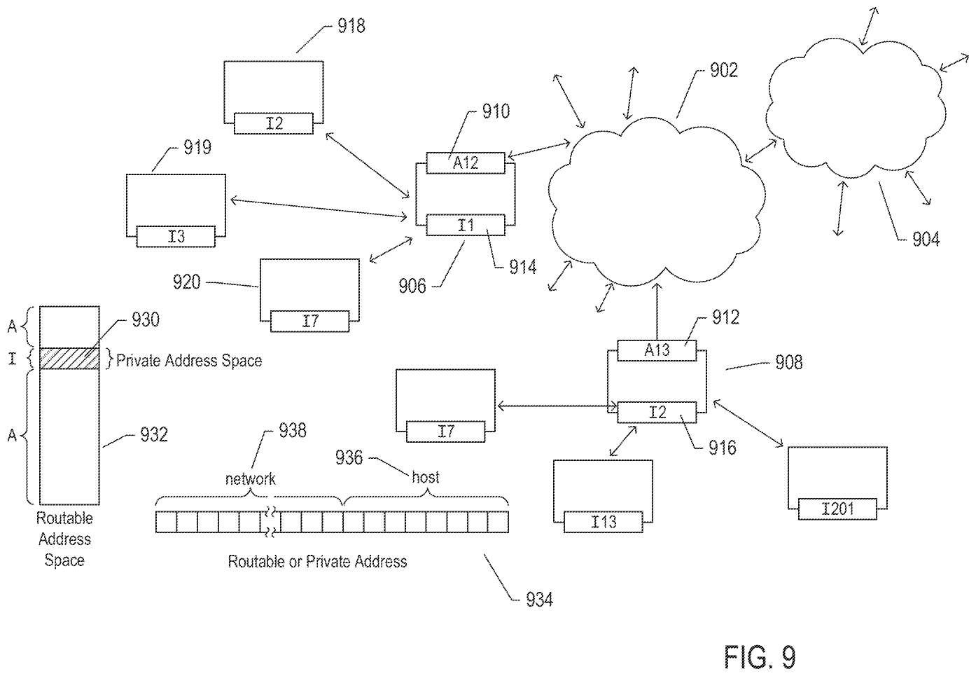

FIG. 9 illustrates private network addresses. When the WAN 802 in FIG. 8 is a large network or group of networks, such as the Internet, and when there are 32 bits in each routable address, there are around 4.3 billion possible routable addresses. In the early days of the Internet, this was a sufficient number of routable addresses for all of the different processor-controlled devices that needed to be connected to the Internet. However, as the Internet became the equivalent of a digital interstate-highway network and the number of Internet-connected devices exponentially increased, the 4.3 billion possible routable addresses quickly became insufficient. One approach to addressing this problem is to increase n. Another approach is to use the routable addresses for connecting only a subset of the processor-controlled devices directly to the Internet, such as routers, and to use private local-area-network addresses for local processor-controlled devices connected to the Internet through the routers. Both approaches have been used. The second approach is illustrated in FIG. 9. The Internet can be viewed as a large set of multiple interconnected networks, such as networks 902 and 904 shown in FIG. 9. Two routers 906 and 908 are shown to be connected to network 902. Each router has an outward-facing routable address 910 and 912 that allows messages to be routed through the collection of networks to the router. Each router has an inward-facing private network address 914 and 916 that allows the router to communicate with local processor-controlled devices connected to the router within a local-area network, such as processor-controlled devices 918-920 connected to router 906. The local processor-controlled devices use private network addresses and are only indirectly connected to the Internet through router 906. A router can use various techniques for correctly multiplexing the single outward-facing routable address among the local processor-controlled devices so that the local processor-controlled devices can send messages to, and receive messages from, processor-controlled devices external to the local-area network via the Internet, including using port numbers uniquely assigned to local processor-controlled devices or to connections between local processor-controlled devices and external processor-controlled devices in combination with the outward-facing routable address. A small portion 930 of the routable address space 932 is reserved for the private address space, but the private address space can be reused by each of the local-area networks since the private addresses are not visible to external entities. For both routable addresses and private-network addresses, an n-bit address 934 is divided into a host address 936 and a network address 938. The Internet routable address space is further divided into different sections, each of which uses a different number of bits for the network address and a corresponding different number of bits for the host address, to provide for addressing networks of different sizes.

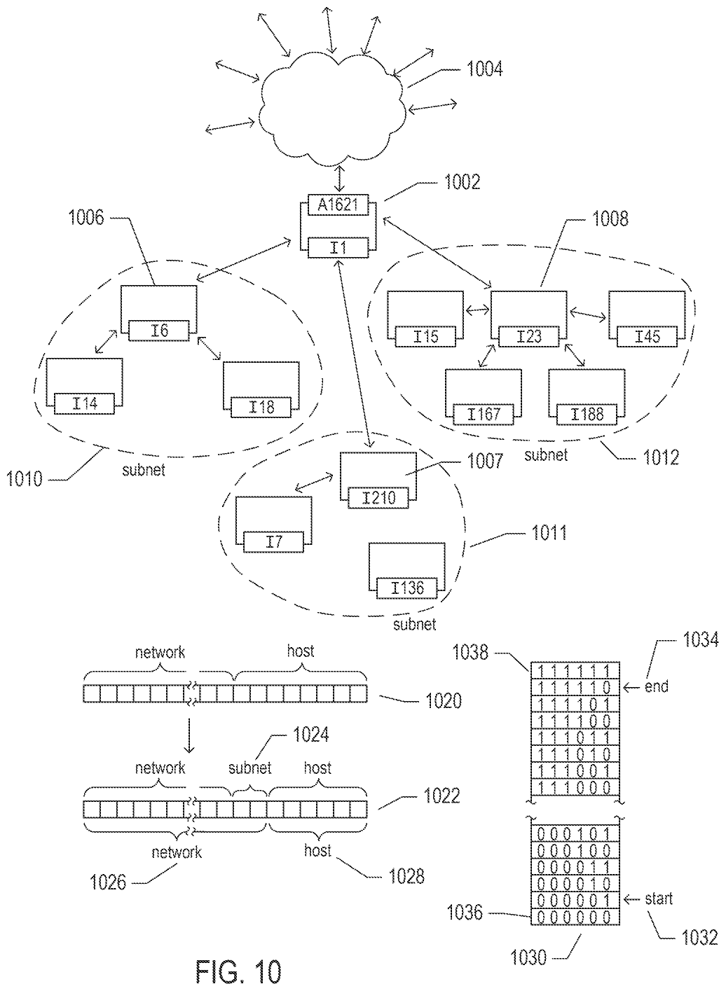

FIG. 10 illustrates the concept of subnetworks or subnets. In FIG. 10, a router 1002 is shown to be connected to a wide-area network 1004 as well as to second-level routers 1006-1008 within three different subnets 1010-1012. The three different subnets may correspond to three different local-area networks. Subnet addresses are obtained by partitioning the host-address space of a private-network-address space. A private-network address 1020 without subnets is converted into a private-network address with subnets 1022 by using a portion 1024 of the host-address space to encode numeric subnet identifiers. The network-address space combined with the subnet-address space results in a new, subnet-enabled network-address space 1026 and a smaller subnet-host-address space 1028. In commonly used network addressing, a subnet-host-address space 1030 includes addresses beginning with a starting address 1032 and ending with an end address 1034 that are assignable to hosts, with a first address 1036 reserved as the subnet address and a final dress 1038 reserved for multicast. Thus, subnetting allows for partitioning of the host-address space into multiple host-address spaces for each of multiple subnets. A subnet can, in turn, be partitioned into subnets of the subnet.

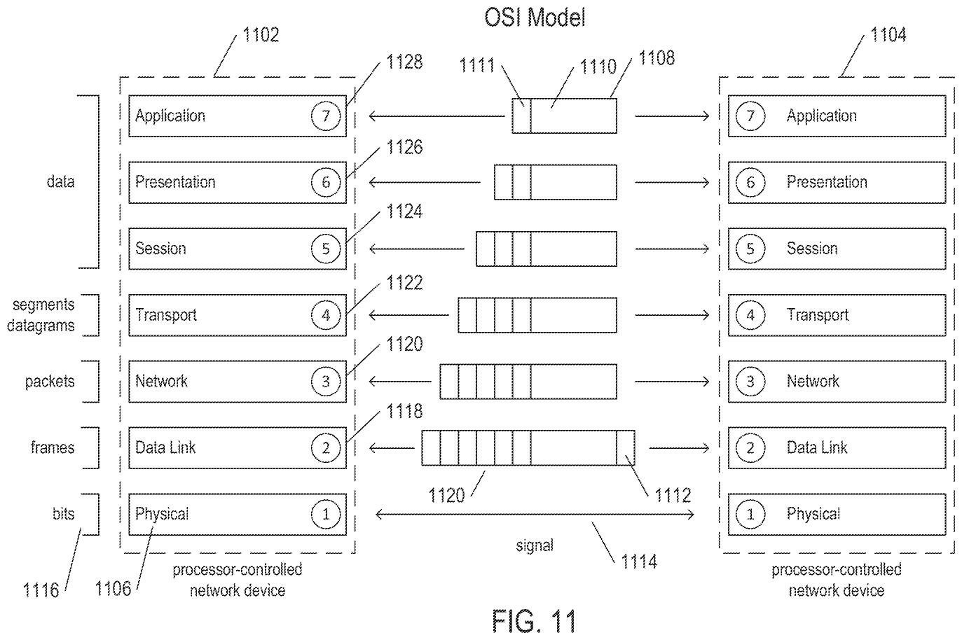

FIG. 11 illustrates the Open Systems Interconnection model (“OSI model”) that characterizes many modern approaches to implementation of communications systems that interconnect computers. In FIG. 11, two processor-controlled network devices, or computer systems, are represented by dashed rectangles 1102 and 1104. Within each processor-controlled network device, a set of communications layers are shown, with the communications layers both labeled and numbered. For example, the first communications level 1106 in network device 1102 represents the physical layer which is alternatively designated as layer 1. The communications messages that are passed from one network device to another at each layer are represented by divided rectangles in the central portion of FIG. 11, such as divided rectangle 1108. The largest rectangular division 1110 in each divided rectangle represents the data contents of the message. Smaller rectangles, such as rectangle 1111, represent message headers that are prepended to a message by the communications subsystem in order to facilitate routing of the message and interpretation of the data contained in the message, often within the context of an interchange of multiple messages between the network devices. Smaller rectangle 1112 represents a footer appended to a message to facilitate data-link-layer frame exchange. As can be seen by the progression of messages down the stack of corresponding communications-system layers, each communications layer in the OSI model generally adds a header or a header and footer specific to the communications layer to the message that is exchanged between the network devices.

It should be noted that while the OSI model is a useful conceptual description of the modern approach to electronic communications, particular communications-systems implementations may depart significantly from the seven-layer OSI model. However, in general, the majority of communications systems include at least subsets of the functionality described by the OSI model, even when that functionality is alternatively organized and layered.

The physical layer, or layer 1, represents the physical transmission medium and communications hardware. At this layer, signals 1114 are passed between the hardware communications systems of the two network devices 1102 and 1104. The signals may be electrical signals, optical signals, or any other type of physically detectable and transmittable signal. The physical layer defines how the signals are interpreted to generate a sequence of bits 1116 from the signals. The second data-link layer 1118 is concerned with data transfer between two nodes, such as the two network devices 1102 and 1104. At this layer, the unit of information exchange is referred to as a “data frame” 1120. The data-link layer is concerned with access to the communications medium, synchronization of data-frame transmission, and checking for and controlling transmission errors. The third network layer 1120 of the OSI model is concerned with transmission of variable-length data sequences between nodes of a network. This layer is concerned with networking addressing, certain types of routing of messages within a network, and disassembly of a large amount of data into separate frames that are reassembled on the receiving side. The fourth transport layer 1122 of the OSI model is concerned with the transfer of variable-length data sequences from a source node to a destination node through one or more networks while maintaining various specified thresholds of service quality. This may include retransmission of packets that fail to reach their destination, acknowledgement messages and guaranteed delivery, error detection and correction, and many other types of reliability. The transport layer also provides for node-to-node connections to support multi-packet and multi-message conversations, which include notions of message sequencing. Thus, layer 4 can be considered to be a connections-oriented layer. The fifth session layer of the OSI model 1124 involves establishment, management, and termination of connections between application programs running within network devices. The sixth presentation layer 1126 is concerned with communications context between application-layer entities, translation and mapping of data between application-layer entities, data-representation independence, and other such higher-level communications services. The final seventh application layer 1128 represents direct interaction of the communications systems with application programs. This layer involves authentication, synchronization, determination of resource availability, and many other services that allow particular applications to communicate with one another on different network devices. The seventh layer can thus be considered to be an application-oriented layer.

In the widely used TCP/IP communications protocol stack, the seven OSI layers are generally viewed as being compressed into a data-frame layer, which includes OSI layers 1 and 2, a transport layer, corresponding to OSI layer 4, and an application layer, corresponding to OSI layers 5-7. These layers are commonly referred to as “layer 2.” “layer 4,” and “layer 7.” to be consistent with the OSI terminology.

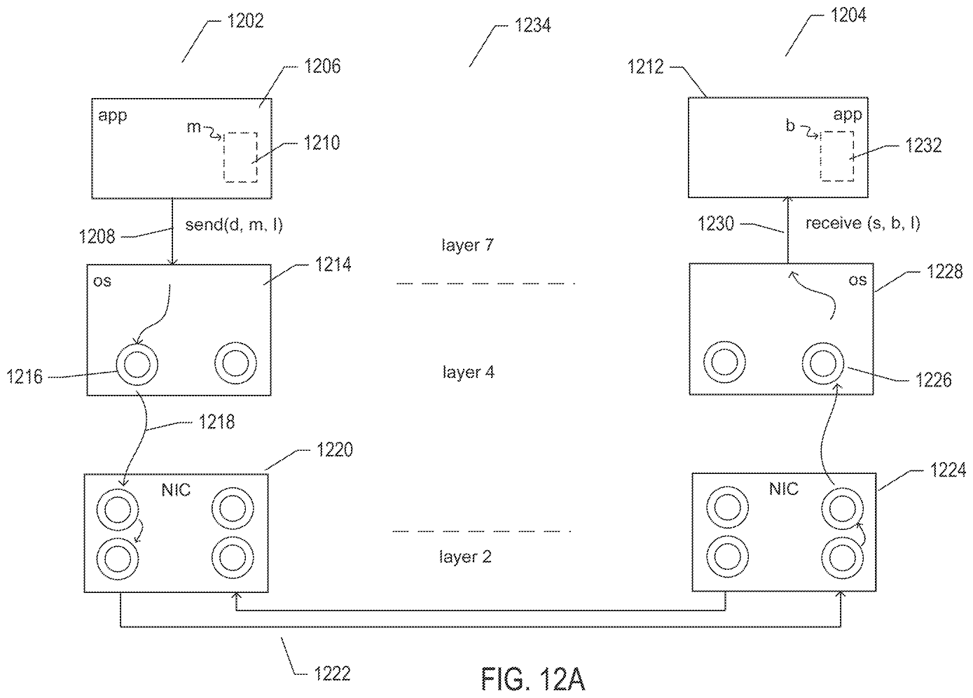

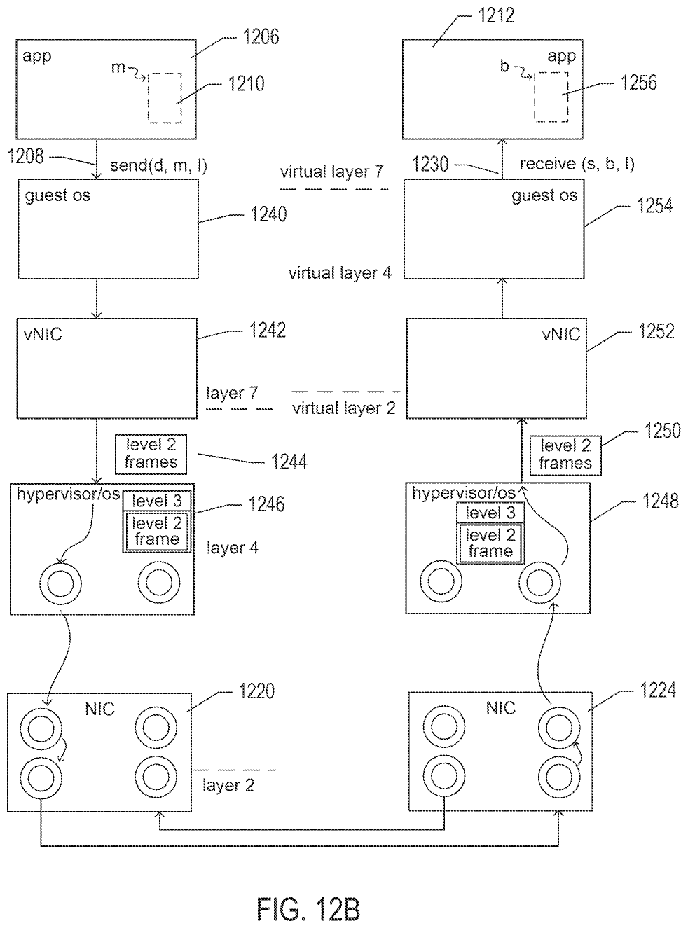

FIGS. 12A-B illustrate a layer-2-over-layer-3 encapsulation technology on which virtualized networking can be based. FIG. 12A shows traditional network communications between two applications running on two different computer systems. Representations of components of the first computer system are shown in a first column 1202 and representations of components of the second computer system are shown in a second column 1204. An application 1206 running on the first computer system calls an operating-system function, represented by arrow 1208, to send a message 1210 stored in application-accessible memory to an application 1212 running on the second computer system. The operating system on the first computer system 1214 moves the message to an output-message queue 1216 from which it is transferred 1218 to a network-interface-card (“NIC”) 1220, which decomposes the message into frames that are transmitted over a physical communications medium 1222 to a NIC 1224 in the second computer system. The received frames are then placed into an incoming-message queue 1226 managed by the operating system 1228 on the second computer system, which then transfers 1230 the message to an application-accessible memory 1232 for reception by the second application 1212 running on the second computer system. In general, communications are bidirectional, so that the second application can similarly transmit messages to the first application. In addition, the networking protocols generally return acknowledgment messages in response to reception of messages. As indicated in the central portion of FIG. 12A 1234, the NIC-to-NIC transmission of data frames over the physical communications medium corresponds to layer-2 (“L2”) network operations and functionality, layer-4 (“L4”) network operations and functionality are carried out by a combination of operating-system and NIC functionalities, and the system-call-based initiation of a message transmission by the application program and operating system represents layer-7 (“L7”) network operations and functionalities. The actual precise boundary locations between the layers may vary depending on particular implementations.

FIG. 12B shows use of a layer-2-over-layer-3 encapsulation technology in a virtualized network communications scheme. FIG. 12B uses similar illustration conventions as used in FIG. 12A. The first application 1206 again employs an operating-system call 1208 to send a message 1210 stored in local memory accessible to the first application. However, the system call, in this case, is received by a guest operating system 1240 running within a virtual machine. The guest operating system queues the message for transmission to a virtual NIC 1242 (“vNIC”), which transmits L2 data frames 1244 to a virtual communications medium. What this means, in the described implementation, is that the L2 data frames are received by a hypervisor 1246, which packages the L2 data frames into L3 data packets and then either directly, or via an operating system, provides the L3 data packets to a physical NIC 1220 for transmission to a receiving physical NIC 1224 via a physical communications medium. In other words, the L2 data frames produced by the virtual NIC are encapsulated in higher-level-protocol packets or messages that are then transmitted through a normal communications protocol stack and associated devices and components. The receiving physical NIC reconstructs the L3 data packets and provides them to a hypervisor and/or operating system 1248 on the receiving computer system, which unpackages the L2 data frames 1250 and provides the L2 data frames to a vNIC 1252. The vNIC, in turn, reconstructs a message or messages from the L2 data frames and provides a message to a guest operating system 1254, which reconstructs the original application-layer message 1256 in application-accessible memory. Of course, the same process can be used by the application 1212 on the second computer system to send messages to the application 1206 and the first computer system.

The layer-2-over-layer-3 encapsulation technology provides a basis for generating complex virtual networks and associated virtual-network elements, such as firewalls, routers, edge routers, and other virtual-network elements within a virtual data centers, discussed above, with reference to FIGS. 7-10, in the context of a preceding discussion of virtualization technologies that references FIGS. 4-6. Virtual machines and vNICs are implemented by a virtualization layer, and the layer-2-over-layer-3 encapsulation technology allows the L2 data frames generated by a vNIC implemented by the virtualization layer to be physically transmitted, over physical communications facilities, in higher-level protocol messages or, in some cases, over internal buses within a server, providing a relatively simple interface between virtualized networks and physical communications networks.

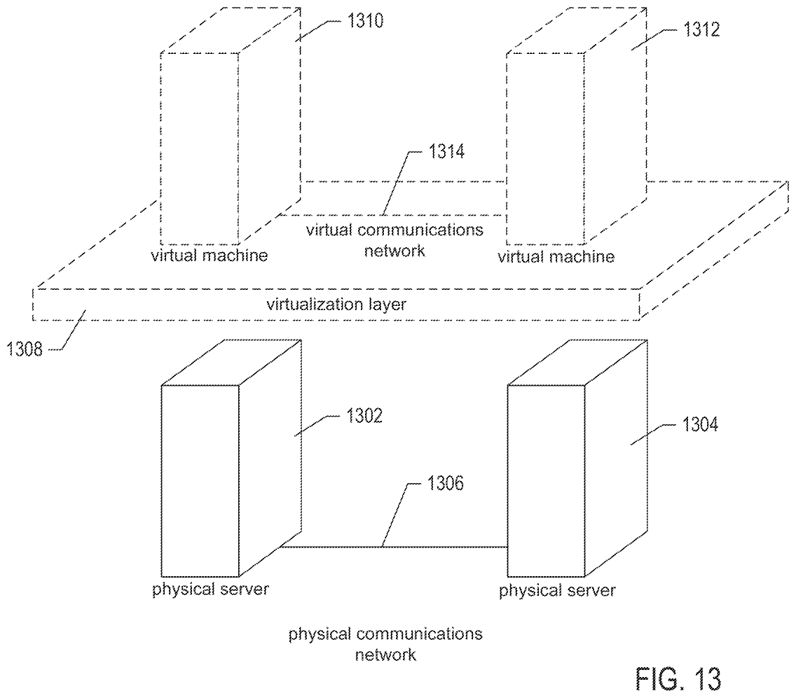

FIG. 13 illustrates virtualization of two communicating servers. A first physical server 1302 and a second physical server 1304 are interconnected by physical communications network 1306 in the lower portion of FIG. 13. Virtualization layers running on both physical servers together compose a distributed virtualization layer 1308, which can then implement a first virtual machine (“VM”) 1310 and a second VM 1312 that are interconnected by a virtual communications network 1314. The first VM and the second VM may both execute on the first physical server, may both execute on the second physical server, or one VM may execute on one of the two physical servers and the other VM may execute on another of the two physical servers. The VMs may move from one physical server to another while executing applications and guest operating systems. The characteristics of the VMs, including computational bandwidths, memory capacities, instruction sets, and other characteristics, may differ from the characteristics of the underlying servers. Similarly, the characteristics of the virtual communications network 1314 may differ from the characteristics of the physical communications network 1306. As one example, the virtual communications network 1314 may provide for interconnection of 10, 20, or more virtual machines, and may include multiple local virtual networks bridged by virtual switches or virtual routers, while the physical communications network 1306 may be a local area network (“LAN”) or point-to-point data exchange medium that connects only the two physical servers to one another. In essence, the virtualization layer 1308 can construct any number of different virtual machines and virtual communications networks based on the underlying physical servers and physical communications network. Of course, the virtual machines' operational capabilities, such as computational bandwidths, are constrained by the aggregate operational capabilities of the two physical servers and the virtual networks' operational capabilities are constrained by the aggregate operational capabilities of the underlying physical communications network, but the virtualization layer can partition the operational capabilities in many different ways among many different virtual entities, including virtual machines and virtual networks.

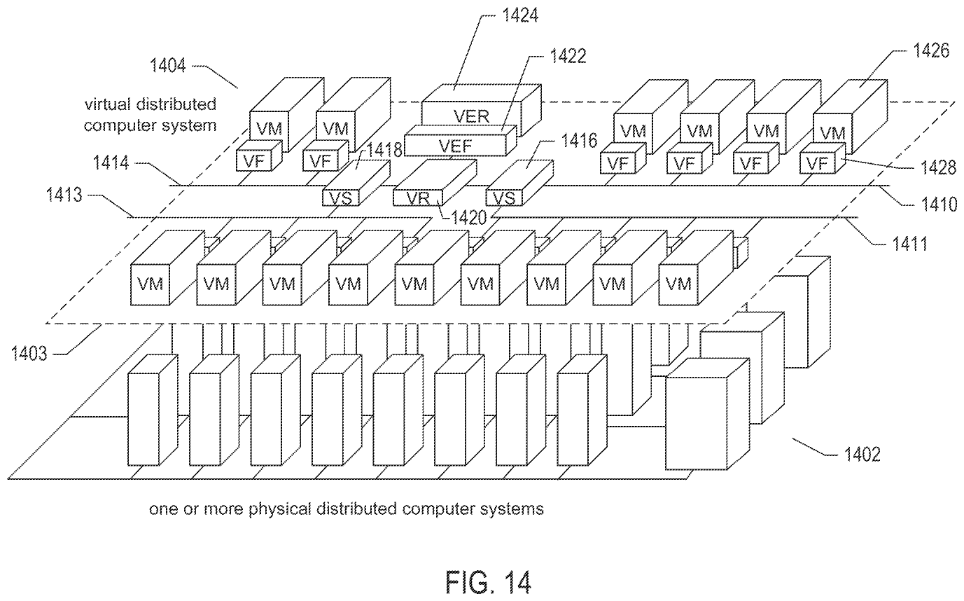

FIG. 14 illustrates a virtual distributed computer system based on one or more distributed computer systems. The one or more physical distributed computer systems 1402 underlying the virtual/physical boundary 1403 are abstracted, by virtualization layers running within the physical servers, as a virtual distributed computer system 1404 shown above the virtual/physical boundary. In the virtual distributed computer system 1404, there are numerous virtual local area networks (“LANs”) 1410-1414 interconnected by virtual switches (“vSs”) 1416 and 1418 to one another and to a virtual router (“vR”) 1421. The vR interconnects the virtual router through a virtual edge-router firewall (“vEF”) 1422 to a virtual edge router (“vER”) 1424 that, in turn, interconnects the virtual distributed computer system with external data centers, external computers, and other external network-communications-enable devices and systems. A large number of virtual machines, such as virtual machine 1426, are connected to the LANs through virtual firewalls (“vFs”), such as vF 1428. The VMs, vFs, vSs, vR, vEF, and vER are implemented largely by execution of stored computer instructions by the hypervisors within the physical servers, and while underlying physical resources of the one or more physical distributed computer systems are employed to implement the virtual distributed computer system. The components, topology, and organization of the virtual distributed computer system are largely independent from the underlying one or more physical distributed computer systems.

Virtualization provides many important and significant advantages. Virtualized distributed computer systems can be configured and launched in time frames ranging from seconds to minutes, while physical distributed computer systems often require weeks or months for construction and configuration. Virtual machines can emulate many different types of physical computer systems with many different types of physical computer-system architectures, so that a virtual distributed computer system can run many different operating systems, as guest operating systems, that would otherwise not be compatible with the physical servers of the underlying one or more physical distributed computer systems. Similarly, virtual networks can provide capabilities that are not available in the underlying physical networks. As one example, the virtualized distributed computer system can provide firewall security to each virtual machine using vFs, as shown in FIG. 14. This allows a much finer granularity of network-communications security, referred to as “microsegmentation,” than can be provided by the underlying physical networks. Additionally, virtual networks allow for partitioning of the physical resources of an underlying physical distributed computer system into multiple virtual distributed computer systems, each owned and managed by different organizations and individuals, that are each provided full security through completely separate internal virtual LANs connected to virtual edge routers. Virtualization thus provides capabilities and facilities that are unavailable in non-virtualized distributed computer systems and that provide enormous improvements in the computational services that can be obtained from a distributed computer system.

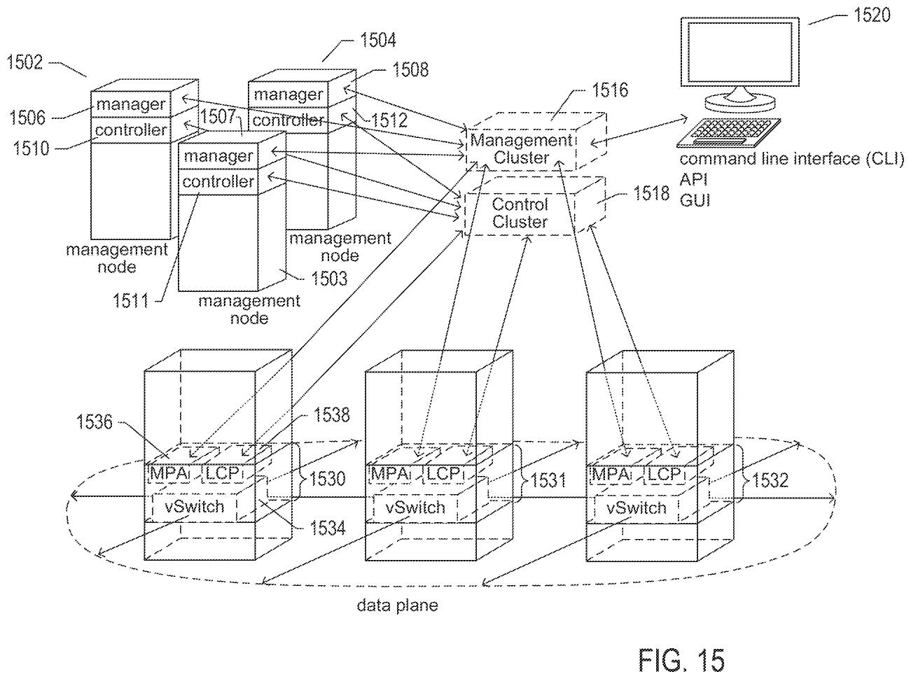

FIG. 15 illustrates components of several implementations of a virtual network within a distributed computing system. The virtual network is managed by a set of three or more management nodes 1502-1504, each including a manager instance 1506-1508 and a controller instance 1510-1512. The manager instances together comprise a management cluster 1516 and the controllers together comprise a control cluster 1518. The management cluster is responsible for configuration and orchestration of the various virtual networking components of the virtual network, discussed above, and provisioning of a variety of different networking, edge, and security services. The management cluster additionally provides administration and management interfaces 1520, including a command-line interface (“CLI”), an application programming interface (“API”), and a graphical-user interface (“GUI”), through which administrators and managers can configure and manage the virtual network. The control cluster is responsible for propagating configuration data to virtual-network components implemented by hypervisors within physical servers and facilitates various types of virtual-network services. The virtual-network components implemented by the hypervisors within physical servers 1530-1532 provide for communications of messages and other data between virtual machines, and are collectively referred to as the “data plane.” Each hypervisor generally includes a virtual switch, such as virtual switch 1534, a management-plane agent, such as management-plane agent 1536, and a local-control-plane instance, such as local-control-plane instance 1538, and other virtual-network components. A virtual network within the virtual distributed computing system is, therefore, a large and complex subsystem with many components and associated data-specified configurations and states.

### Cloud-Infrastructure Management Systems

FIG. 16 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 1602. Each cloud-computing facility provides a management interface, such as management interface 1604 associated with cloud-computing facility 1602. The organization leases computational resources from a number of native-public-cloud cloud-computing facilities 1602 and 1606-1610 and also obtains computational resources from multiple private-cloud cloud-computing facilities 1611-1613. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. All of these types of operations involve issuing commands and requests through the management interfaces associated with the cloud-computing facilities. In the example shown in FIG. 16, cloud-computing facilities 1602 and 1606 are accessed through a first type of management interface, cloud-computing facilities 1608 in 1610 are accessed through a second type of management interface, and cloud-computing facilities 1607 and 1609 are accessed through a third type of management interface. The management interfaces associated with private-cloud cloud-computing facilities 1611-1613 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features, In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials which further complicates management operations performed by management and administration personnel. These problems may even be of greater significance when computational resources are leased from cloud-computing facilities and configured and managed by automated management systems.

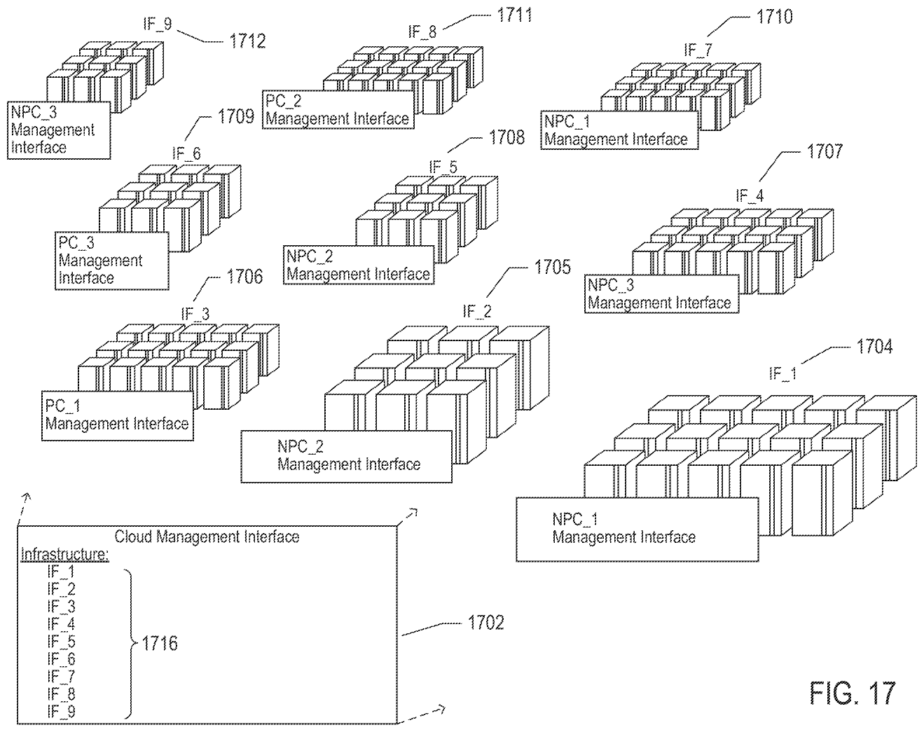

To address the problems associated with multiple different management interfaces to multiple different cloud-computing facilities, discussed in the preceding paragraph, a new class of comprehensive cloud-infrastructure-management services each provides a single, universal management interface through which management and administration personnel as well as automated management systems define and deploy cloud-based infrastructure within many different types of cloud-computing facilities. FIG. 17 illustrates a universal-management-interface provided by a comprehensive cloud-infrastructure-management service. The comprehensive cloud-infrastructure-management service provides a cloud-management interface 1702 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 17 by the labels “IF_1” 1704, “IF_2” 1705, “IF_3” 1706, “IF_4” 1707, “IF_5” 1708, “IF_6” 1709, “IF_7” 1710, “IF_8” 17011, and “IF_9” 1712. The comprehensive cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. A single type of cloud template or blueprint is used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 1702, as indicated by the infrastructure labels 1716 shown within the cloud-management interface.

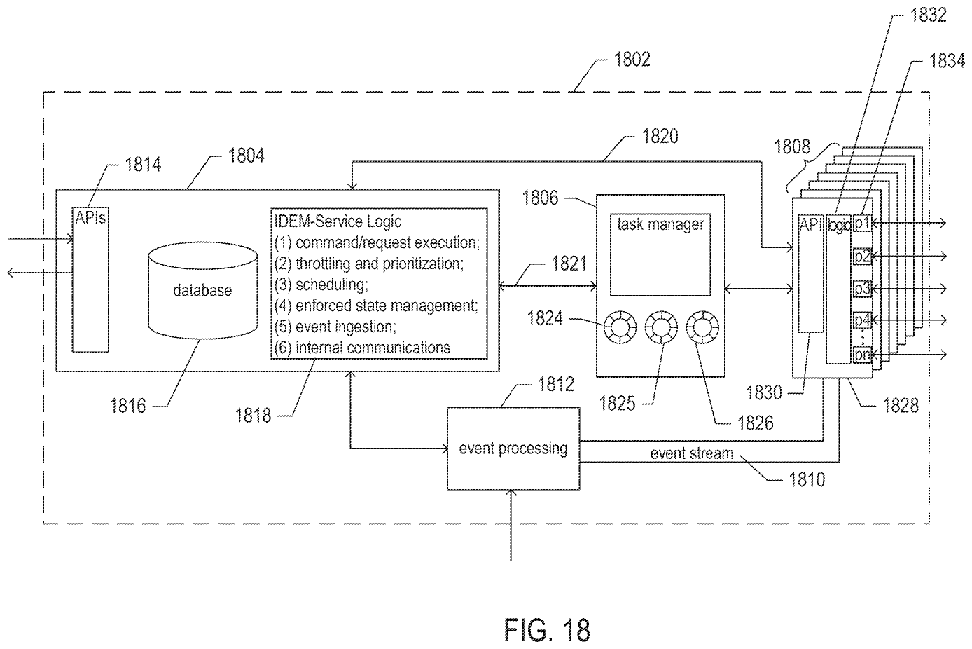

FIG. 18 illustrates one implementation of a comprehensive cloud-infrastructure-management service. The comprehensive cloud-infrastructure-management service 2002 includes a service frontend 1804, a task manager 1806, multiple workers 1808, with the number of workers scalable to handle dynamic workloads, an event stream 1810, and an event-processing component 1812. The frontend 1804 includes a set of APIs 1814 and a database 1816 for storing information related to managed infrastructure and received requests and commands. The frontend additionally includes service logic 1818 that implements command/request execution, throttling and prioritization, scheduling, enforced-state management, event ingestion, and internal communications between the various components of the comprehensive cloud-infrastructure-management service. Throttling involves managing the workload accepted by the Idem service to ensure that sufficient computational resources are available to execute received commands and requests. Prioritization involves prioritizing execution of received commands and requests. Scheduling involves preemption of long-running command-and-request executions. Event ingestion involves receiving, storing, and acting on events input to the frontend by the event-processing component 1812. The various components of the comprehensive cloud-infrastructure-management service communicate by message passing, as indicated by double-headed arrows 1820-1822. The task manager 1806 coordinates various stages of execution of commands and requests using numerous task queues 1824-1826. Each worker, such as worker 1828, presents a worker API 1830 and includes logic 1832 that implements command-and-request execution. Each worker includes a set of one or more plug-ins, such as plug-in 1834, allowing the worker to access the management interfaces of cloud-computing facilities on which infrastructure managed by the comprehensive cloud-infrastructure-management service is deployed and configured. As they execute commands and requests, workers publish events to the event stream 1810. These events are monitored and processed by the event-processing component 1812, which filters the events and forwards processed events to the Idem-service frontend.

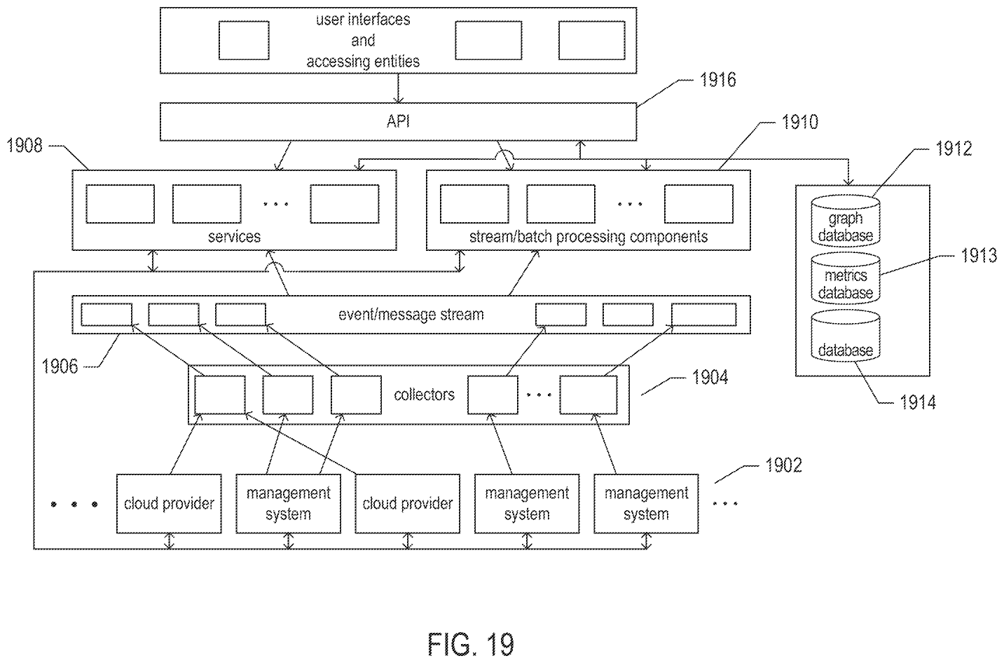

FIG. 19 illustrates the architecture of a second comprehensive cloud-infrastructure-management system that aggregates the functionalities of multiple cloud-provider distributed management systems and other management systems, including distributed-application management systems, to provide a consistent, uniform view of multiple cloud-computing systems and a single management interface to users. The lowest level 1902 of the architecture illustrated in FIG. 19 represents multiple different cloud-provider distributed management systems and other management systems that are aggregated together by the second comprehensive cloud-infrastructure-management system. A next higher-level 1904 represents multiple different collectors implemented as collector processes that continuously access the multiple different cloud-provider distributed management systems and other management systems to obtain inventory and configuration information with regard to the managed computational resources and additional information related to the physical and virtual cloud-computing facilities and data centers that contain them. The collectors may receive event streams, may access data through management interfaces, or, typically, both. The collectors carry out initial processing on the information they collect and input the collected information to a central data bus 1906 implemented, in one implementation, by an event-streaming system. The information input to the central data bus is accessed by multiple different microservices 1908 and stream/batch processing components 1910. At least three different databases 1912-1914 store management data. In one implementation, a graph-based inventory/configuration data-model/database 1912 is used to store inventory and configuration information for the managed computational resources and their computational environments. A specialized metrics database 1913 is used to store metric data derived by derived-data services of the second comprehensive cloud-infrastructure-management system, which may generate derived-metric data from metrics obtained from the various cloud-provider distributed management systems and other management systems 1902, from information stored in the graph database 1912, and from additional sources. A third database 1914 stores various types of derived data generated by the microservices 1908 and stream/batch processing components 1910, including business insights, and other generated information. The second comprehensive cloud-infrastructure-management system provides an API 1916 through which the various different types of data maintained by the second comprehensive cloud-infrastructure-management system can be accessed and through which many different management functionalities provided by the second comprehensive cloud-infrastructure-management system can be accessed by external computational entities and one or more different user interfaces. A stitching process, or another similar process or service, is used to combine the schemas associated with the APIs provided by the various different microservices 1908 and stream/batch processing components 1910 in order to support queries, mutations, and subscriptions that are implemented across multiple different microservices and stream/batch processing components. The second comprehensive cloud-infrastructure-management system maintains a single inventory/configuration graph-based data model for the managed computational resources and their computational environments that is generated from inventory/configuration information collected from the multiple different underlying cloud-provider distributed management systems and other management systems 1902, each of which generally creates and maintains a separate and different inventory/configuration data model and database.

### Currently Disclosed Methods and Systems

The currently disclosed methods and systems are related to improved cloud-infrastructure deployment by cloud-infrastructure-management systems, including efficient allocation and provisioning of virtual networks during cloud-template-directed cloud-infrastructure deployment. The currently disclosed methods can be incorporated into various different types of cloud-infrastructure-management systems, including those discussed in the preceding section. As further discussed below, cloud-infrastructure-management systems currently lack features that allow for efficient allocation of network resources during cloud-template-directed cloud-infrastructure deployment and use relatively simplistic network-resource-allocation methods. The currently disclosed improved methods and systems address these deficiencies of currently available cloud-infrastructure-management systems and cloud-infrastructure-deployment methods.

FIGS. 20-23 illustrates various data structures and stored information used by a representative cloud-infrastructure-management system during cloud-template-based infrastructure deployment. FIG. 20 shows cloud-account, cloud-zone, and project data structures along with a cloud template. The cloud-account data structure 2002 collects and stores credentials, roles, and authentication and authorization information that allows an individual or organization to access the management systems provided by a cloud provider, such as native-public cloud-services and private cloud-computing facilities. A cloud account includes an indication of, or a reference 2004 to, the cloud provider for which the cloud account includes access credentials and information and includes the collected credentials, roles, and authentication and authorization information 2006 needed to access the management interface or interfaces provided by the cloud provider. In addition, a cloud account includes indications of, or references to, multiple different regions 2008-2011, such as virtual data centers, to which infrastructure deployments can be directed through the cloud-provider management system or systems.

A cloud-zone data structure 2012 represents a number of computational resources, such as virtual machines, virtual data-storage appliances, and other such computational resources that are available for supporting execution of applications and services within a region, or cloud-computing facility, of a cloud provider. The cloud-zone data structure includes indications of, or references to, the cloud provider 2014 and to a cloud-provider region 2016. The cloud-zone data structure includes a list of resources 2018, with each resource described by an identifier, a set of properties, with each property comprising a property/value pair, and, optionally, a set of one or more capability tags. The cloud-zone data structure may also include one or more placement policies 2020, a set of one or more capability tags 2022, and a set of compute tags 2024. A project data structure 2030 represents a related set of infrastructure deployments that are aggregated under the management of a particular administrator or organization. A project data structure includes a set of indications of, or references to, cloud-zone data structures 2032 and may additionally include a set of placement policies 2034, project resource tags 2036, project constraint tags 2038, and project properties 2040. A cloud template 2050 is a formatted document that specifies cloud infrastructure for deployment to one or more cloud-computing systems of one or more cloud providers. In addition to a name/identifier and other such information, a cloud template includes an indication of, or reference to, a project data structure 2052 and a list of resources 2054. Each resource is described by a name, a set of properties, and, optionally, a set of one or more constraint tags. Deployments of cloud infrastructure specified in a cloud template involves matching the properties and constraint tags of the resources listed in the cloud template with properties and capability tags of resources listed in one or more cloud-zone data structures as well as ensuring adherence to various placement policies and compatibility with various higher-level capability tags and constraints associated with additional data structures. When matching resources within cloud-provider regions can be found, the resources can be allocated for deployment of the cloud infrastructure specified by a cloud template and then provisioned from one or more cloud providers by a cloud-infrastructure-management system. Note that a cloud template may be shared for access by projects other than the project referenced by the cloud template.

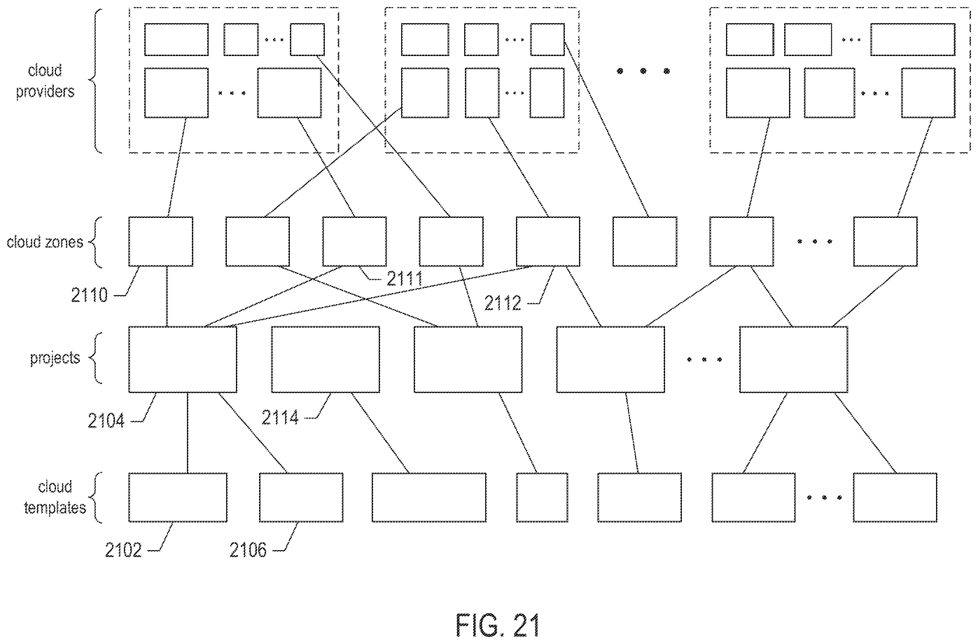

FIG. 21 illustrates relationships between cloud-providers, cloud-provider regions, cloud-zone data structures, project data structures, and cloud templates. Each cloud template, such as cloud-template 2102, is associated with a particular project. A project can be associated with multiple different cloud templates, such as project 2104, which is associated with cloud templates 2102 and 2106. A project, such as the project described by project data structure 2104, can access resources described by one or more cloud-zone data structures. For example, project data structure 2104 accesses resources described by cloud-zone data structures 2110-2112. A cloud-zone data structure may be accessed by multiple different projects, such as cloud-zone data structure 2110, which is accessed by the projects represented by project data structures 2104 and 2114. Each cloud-zone data structure is associated with a single region of a cloud provider.

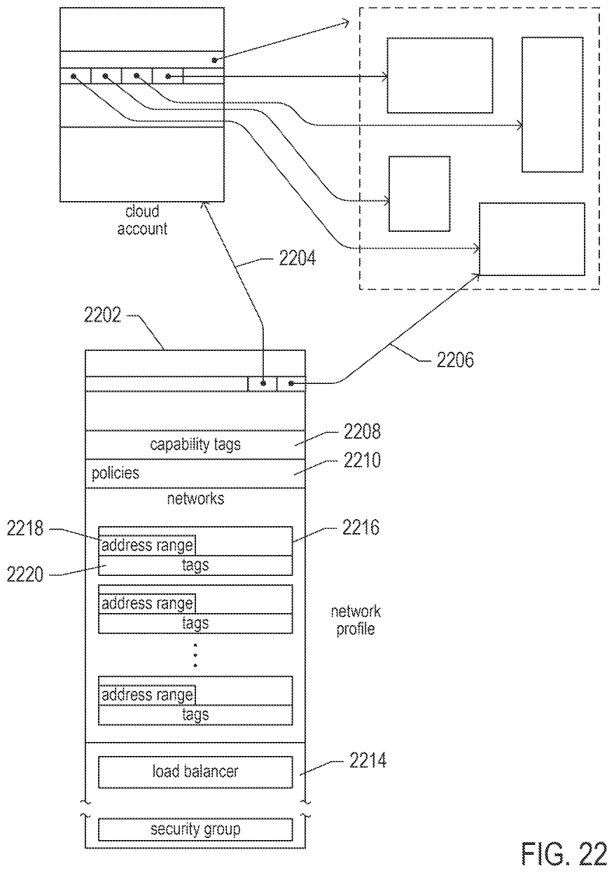

FIG. 22 illustrates a network-profile data structure. Network-profile data structures, such as network-profile data structure 2202, represents virtual-network resources available within a particular cloud-provider region. The network-profile data structure includes an indication of, or reference to, a cloud-account data structure 2204 and a cloud-provider region 2206. A network-profile data structure may include a set of one or more capability tags 2208, a set of one or more policies 2210, a list of networks, or subnets, 2212, and lists of other types of network resources such as load balancers and security groups 2214. The representation of each network, or subnet, such as network 2216, includes an identifier, properties, an available address range or ranges 2218, and a set of one or more network tags 2220.

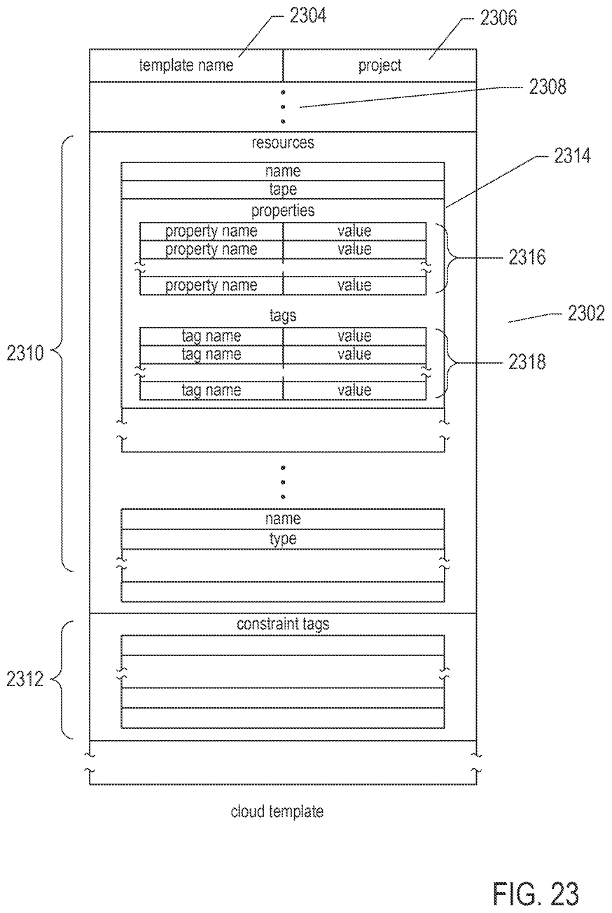

FIG. 23 illustrates a cloud template. The cloud template 2302 includes a name 2304, a reference to a project 2306, other cloud-template information represented by ellipsis 2308, a list of resources 2310, and a list of cloud-template constraint tags 2312. As mentioned above, each resource, such as resource 2314, is specified by a set of properties 2316 and a set of constraint tags 2318. Tags and properties are similar, with properties representing inherent characteristics of resources and tags representing classes or types to which the resources are assigned.

The data structures and cloud template discussed with reference to FIGS. 20-23 are generalized data structures that might be used by a variety of different cloud-infrastructure-management systems. The data structures may include many additional fields, may lack certain of the fields discussed and illustrated in FIGS. 20-23, and may employ different representations and use conventions in various different implementations. The details of the different types of information represented in these data structures are generally not relevant to the currently disclosed methods and systems other than the fact that such information is stored, managed, and used during cloud-infrastructure deployment.

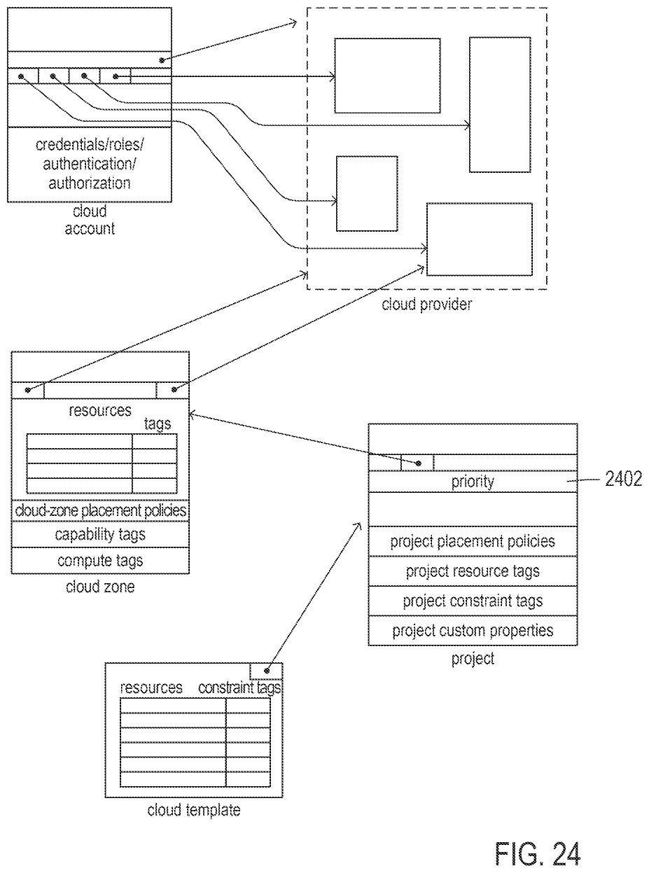

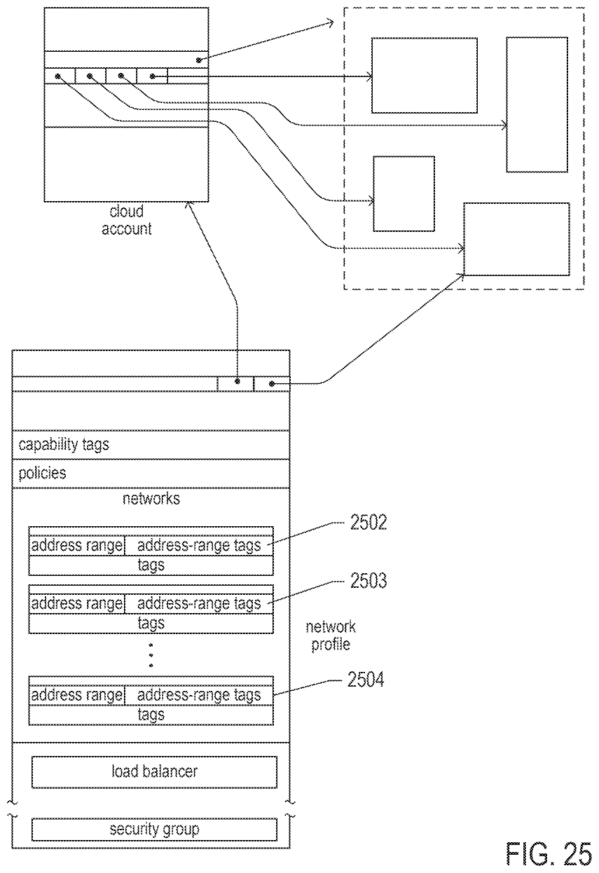

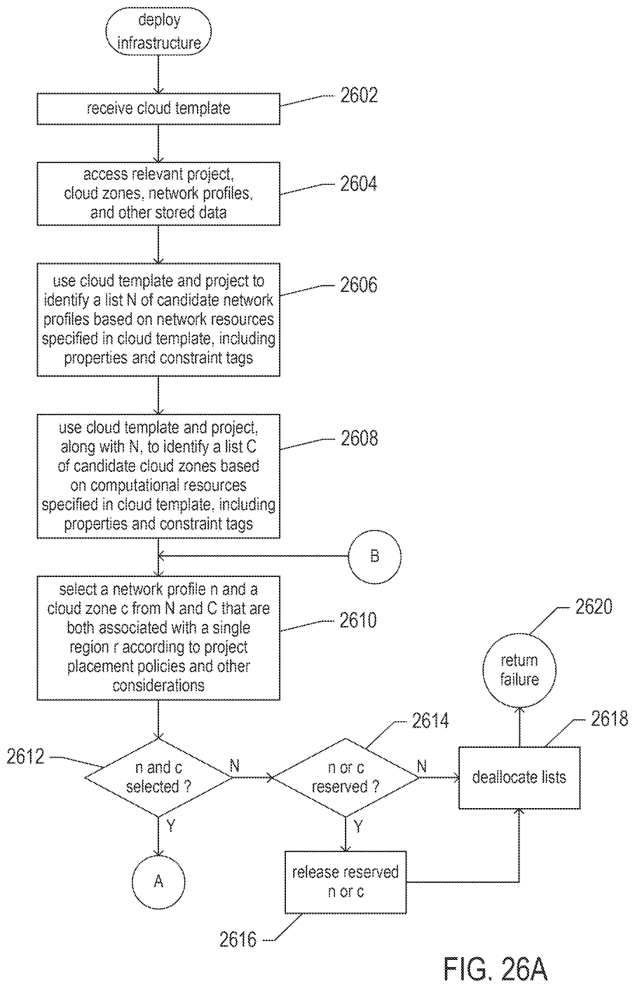

FIGS. 24-25 illustrate several new features added to the project data structure and the network-profile data structure. FIG. 24 is nearly identical to FIG. 20, but includes a new feature added to the project data structure to facilitate the currently disclosed methods. The new feature is a field 2402 that contains a priority value that indicates a deployment priority for cloud-template-based cloud-infrastructure deployments carried out by the project represented by the project data structure. FIG. 25 is nearly identical to FIG. 22, but includes a set of new features added to the network-profile data structure. The new features are address-range tags 2502-2504 associated with the address ranges included in the description of networks, or subnets. These address-range tags allow for fine-granularity specification of address-range-related constraints for cloud infrastructure represented by cloud templates.

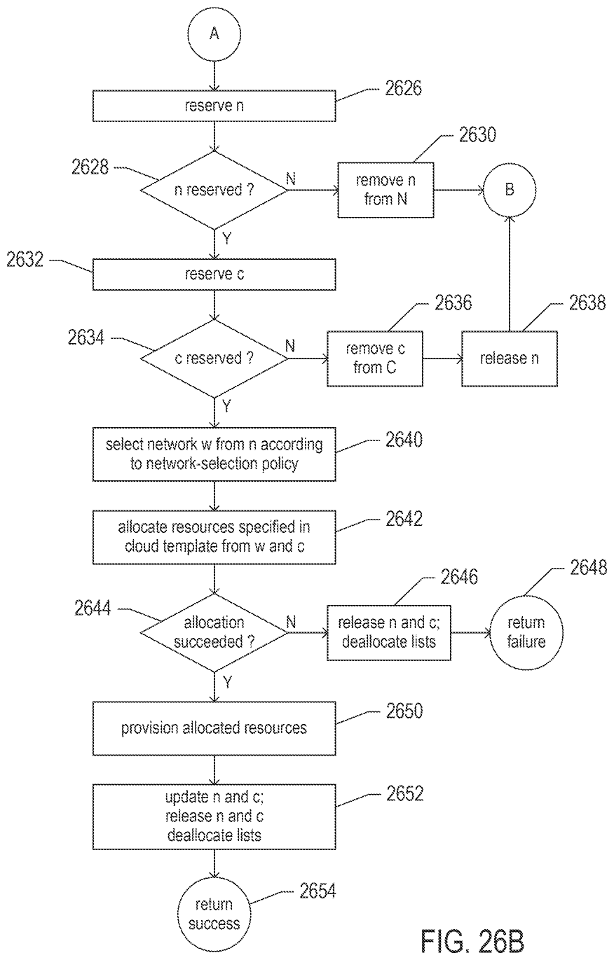

FIGS. 26A-B provide control-flow diagrams for a cloud-infrastructure deployment method that provides an example of current cloud-infrastructure deployment in currently available cloud-infrastructure-management systems. In step 2602 of FIG. 26A, the routine “deploy infrastructure” receives a cloud template that specifies cloud-infrastructure to be deployed. In step 2604, the routine “deploy infrastructure” accesses the relevant project, cloud-zone, and network-profile data structures along with other stored data and information maintained by the cloud-infrastructure-management system to facilitate cloud-structure deployment. In step 2606, the routine “deploy infrastructure” uses the cloud template and associated project data structure to identify a list N of candidate network profiles describing network resources available to the project that would appear to provide the network resources specified in the cloud template. As discussed above, this step involves matching the network resources specified in the cloud template to network resources described in a network profile, including matching properties and constraint tags to capability tags. In step 2608, the routine “deploy infrastructure” uses the cloud template and associated project, and may additionally use the list N of network profiles, to generate a list C of candidate cloud-zone data structures from which the additional computational resources specified in the cloud template can be obtained. This process again involves matching the various computational resources specified in the cloud template to the computational resources described in the cloud-zone data structures, including matching properties and constraint tags to capability tags. In step 2610, the routine “deploy infrastructure” selects a particular network profile n from the list N and a particular cloud zone c from the list C that are both associated with a single region r and that together provide the computational resources needed for deployment of the cloud infrastructure specified in the cloud template and that meet the various constraints and policy considerations included in relevant data structures. When selection of a network-profile/cloud-zone pair from the lists N and Cis unsuccessful, as determined in step 2612, the routine “deploy infrastructure” determines whether one or both of n and c have been reserved, in step 2614. If so, the reserved data structures are released, in step 2616. In step 2618, the lists N and C are deallocated and, in step 2620, a failure indication is returned. In other words, when selection of a network-profile/cloud-zone pair from the lists N and C is unsuccessful, there are insufficient computational resources available to the project to deploy the cloud infrastructure described by the cloud template. When selection of a network-profile/cloud-zone pair from the lists N and C is successful, as determined in step 2612, control flows to step 2626 in FIG. 26B in which the routine “deploy infrastructure” attempts to reserve the network-profile data structure n for resource allocation. A reservation is needed to prevent concurrent access to the network-profile data structure by another independently executing infrastructure-deployment deployment routine or service or by other management functions or services. When the reservation is not successful, as determined in step 2628, the routine “deploy infrastructure” removes n from the list N, in step 2630, following which control flows back to step 2610 in FIG. 26A. When the reservation is successful, as determined in step 2628, the routine “deploy infrastructure” attempts to reserve the cloud-zone data structure c, in step 2632. When the reservation is not successful, as determined in step 2634, the routine “deploy infrastructure” removes c from the list C, in step 2636, and releases the network-profile data structure n in step 2638, following which control flows back to step 2610 in FIG. 26A. When the reservation is successful, as determined in step 2634, the routine “deploy infrastructure” selects a network w from the network profile n that matches the properties and constraints of the specified network resources in the cloud template according to a network-selection policy and other considerations. In step 2642, the routine “infrastructure deployment” allocates resources specified in the cloud template from w and c. When the allocation fails, as determined in step 2644, the routine “deploy infrastructure” releases n and c, deallocates lists N and C, in step 2646, and returns a failure indication in step 2648. The allocation may fail for a variety of different reasons. One reason is that the cloud template may specify that a particular range of addresses is required, and that particular range of addresses may not be available in network w. When the allocation succeeds, as determined in step 2644, the routine “deploy infrastructure” accesses the management interface provided by the cloud provider to provision the allocated resources, in step 2650. In step 2652, the routine “deploy infrastructure” updates network profile n and cloud zone c to reflect the allocation and provisioning of resources, releases network profile n and cloud zone c, and deallocates lists N and C before returning a success indication in step 2654.

There are significant deficiencies and problems associated with the above-described cloud-infrastructure-deployment method. For one thing, it does not accommodate concurrent deployment of multiple cloud infrastructures specified by multiple cloud templates. However, the method may be independently executed on behalf of multiple users to deploy multiple cloud infrastructures, as a result of which a variety of different types of deployment failures may result from various race conditions during resource allocation and provisioning. Moreover, network-resource allocation may be extremely inefficient, with available network resources languishing unused while deployments fail as a result of the inability to identify the available network resources for particular infrastructure deployments. Furthermore, deployment failures, such as the above-mentioned failure when a selected network does not have a required address range, may frequently occur because the network-address-range constraints are not considered when selecting candidate networks. These are but a few of the many problems that are currently encountered when deploying cloud infrastructures by currently available cloud-infrastructure-deployment methods.

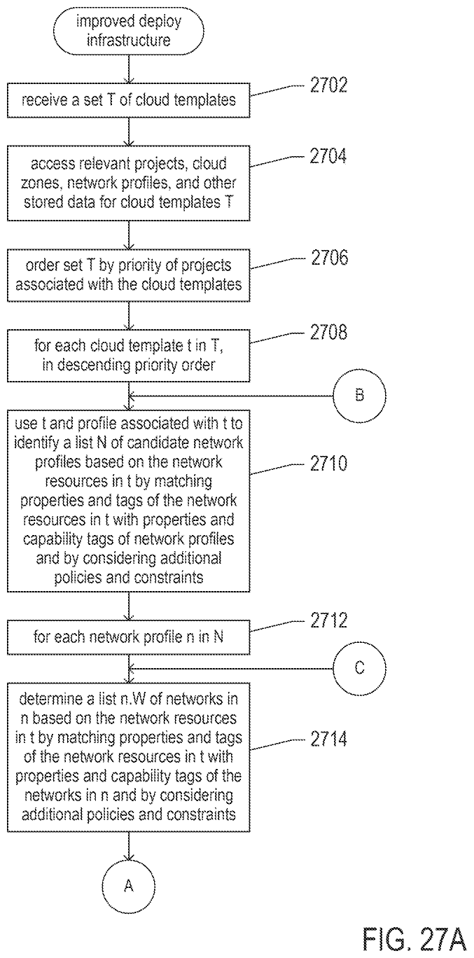

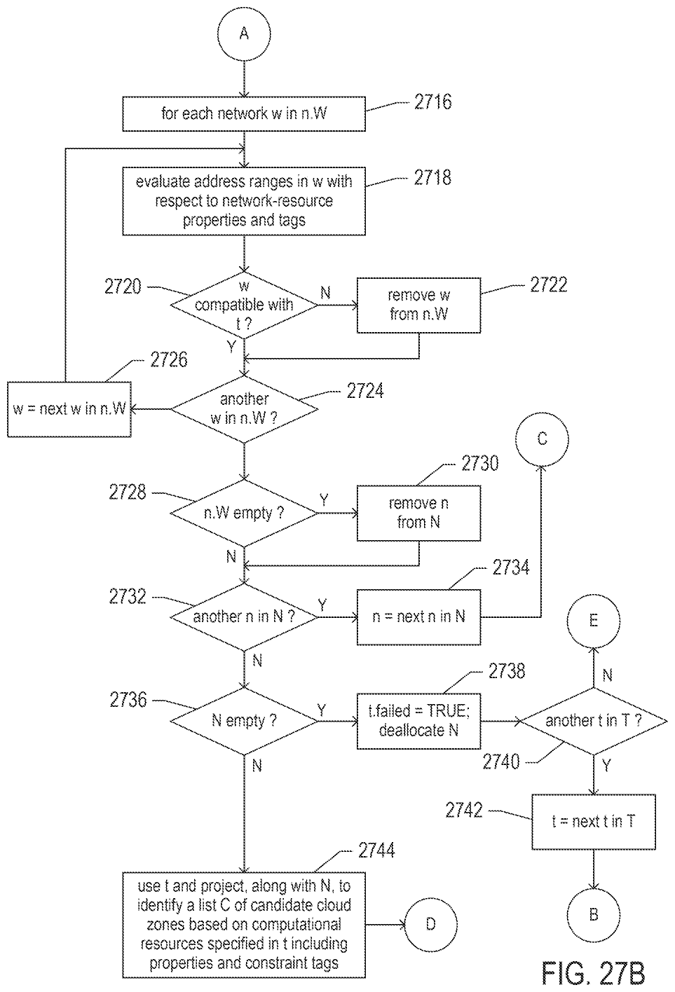

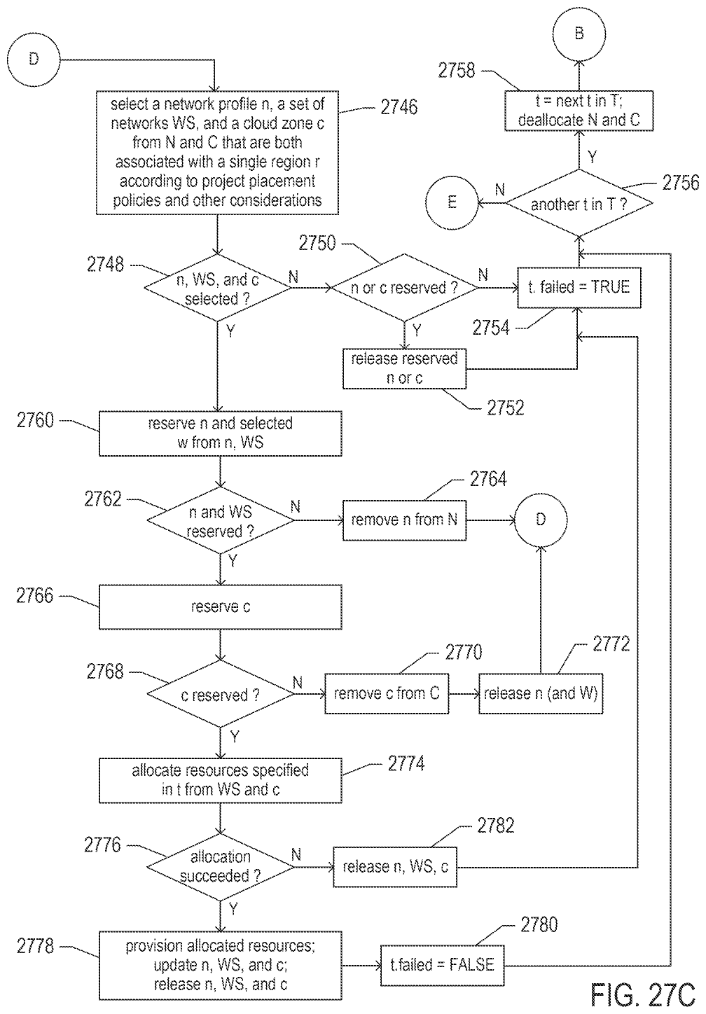

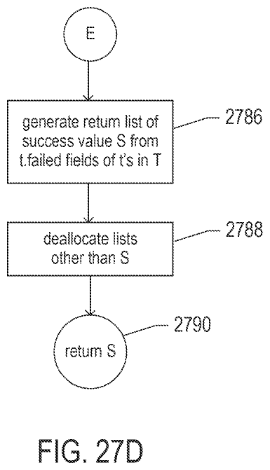

FIGS. 27A-D provide control-flow diagrams that illustrate the currently disclosed improved cloud-infrastructure deployment method incorporated within improved cloud-infrastructure-management systems. In step 2702 of FIG. 27A, the routine “improve deploy infrastructure” receives a set T of cloud templates for concurrent deployment. In step 2704, the routine “improved deploy infrastructure” accesses the relevant projects, cloud zones, network profiles, and other store data with regard to the set of cloud templates T. In step 2706, the cloud templates in the set T are ordered by priority in descending order, with the priorities extracted from the priority field of the projects associated with the cloud templates. Then, in the for-loop beginning with step 2708, the routine “improve deploy infrastructure” considers each cloud template t in Tin descending-priority order. In step 2710, the currently considered cloud template t and the profile associated with cloud template t are used to identify a list N of candidate network profiles based on the network resources specified in t. This process involves matching the specified network resources specified in t to network resources in network profiles using the properties and constraint tags associated with network resources specified in t with properties and capability tags of the network profiles and project, and also involves consideration of additional policies and constraints contained in these data structures. In the nested for-loop that begins with step 2712, the routine “improve deploy infrastructure” considers each candidate network profile n in the list N. In step 2714, the routine “improve deploy infrastructure” generates a candidate list n.W of networks, or subnets, in network profile n, again by matching properties and tags of the network resources specified in cloud template t with the properties and capability tags of the networks, or subnets, and by considering additional policies and constraints. In the nested for-loop that begins with step 2716, in FIG. 27B, the routine “improve deploy infrastructure” considers each network w in the list n.W. In step 2718, routine “improve deploy infrastructure” evaluates the address range or ranges for the currently considered network w with respect to the specified network-resource properties and tags in cloud template t. When the currently considered network w is not compatible with the network-resource properties and tags included in cloud-template t, as determined in step 2720, the currently considered network w is removed from the list n.W, in step 2722. When there is another network to consider in the list n.W, as determined in step 2724, the routine “improve deploy infrastructure” sets w to the next network in the list n.W, in step 2726, following which control returns to step 2718 to evaluate the next network. When there is no further network to consider in the list n.W, as determined in step 2724, the routine “improve deploy infrastructure” determines, in step 2728, whether the list n.W is empty. If so, then candidate network profile n is removed from the list N, in step 2730. When there is another network profile to consider in the list N, as determined in step 2732, the routine “improve deploy infrastructure” sets n to the next network profile in N, in step 2734, following which control returns to step 2714 in FIG. 27A. Otherwise, in step 2736, the routine “improve deploy infrastructure” determines whether the list N is not empty. If so, a field t.failed associated with the cloud template t is set to TRUE and the list N is deallocated, and step 2738. When there is another cloud template in the set of cloud templates T to consider, as determined in step 2740, the routine “improve deploy infrastructure” sets t to the next cloud template in the set T, in step 2742, following which control returns to step 2710 in FIG. 27A. Otherwise, control flows to the first step in FIG. 27D, discussed below. When the list N is not empty, as determined in step 2736, the routine “improve deploy infrastructure” uses cloud template t and the project associated with cloud template t, along with list N, to generate a list C of candidate cloud zones based on the computational resources specified in t, in step 2744. Then, in step 2746 at the top of FIG. 27C, the routine “improve deploy infrastructure” selects a network profile n, a set of networks WS in n, and a cloud zone c from the lists N and C that are associated with a single region r according to project placement policies and other considerations. When this selection fails, as determined in step 2748, the routine “improve deploy infrastructure” determines whether or not one of n and c are reserved, in step 2750. If so, the observed data structures are released, in step 2752. The field failed associated with cloud template t is set to TRUE, in step 2754. When there is another cloud template to consider in the set T, as determined in step 2756, the routine “improve deploy infrastructure” sets t to the next cloud template in T and deallocates lists N and C, in step 2758, after which control flows back to step 2710 in FIG. 27A. Otherwise, control flows to the first step in FIG. 27D, discussed below. When the selection attempted in step 2746 succeeds, as determined in step 2748, the routine “improve deploy infrastructure” attempts to reserve network profile n along with the set of networks WS, in step 2760. When the reservation fails, as determined in step 2762, the routine “improve deploy infrastructure” removes network profile n from the list N, in step 2764, following which control returns to step 2746. Otherwise, the routine “improve deploy infrastructure” attempts to reserve the cloud zone c in step 2766. When the reservation fails, as determined in step 2768, the routine “improve deploy infrastructure” removes c from the list C, in step 2770, and releases network profile n in step 2772, after which control returns to step 2746. Otherwise, in step 2774, the routine “improve deploy infrastructure” deallocates the resources specified in cloud template t from the set of networks WS and the cloud zone c. When the allocation succeeds, as determined in step 2776, the routine “improve deploy infrastructure” provisions the allocated resources, updates n, WS, and c, and releases n, WS, and c in step 2778. The routine “improve deploy infrastructure” then sets the field failed associated with cloud template 1 to false, in step 2780, after which control returns to step 2756. When the allocation fails, as determined in step 2776, the routine “improve deploy infrastructure” releases n, WS, and c, in step 2782, following which control flows back to step 2754. In the first step of FIG. 27D, step 2786, the routine “improve deploy infrastructure” generates a return list of success values S from the failed fields associated with the cloud templates in T. In step 2788, any lists other than S are deallocated. Finally, in step 2790, the routine “improve deploy infrastructure” returns the list of success values S.

The improved cloud-infrastructure deployment method illustrated in FIGS. 27A-D and described in the preceding paragraph addresses the deficiencies discussed in currently available cloud-infrastructure deployment methods. It is designed to carry out concurrent deployment of multiple cloud templates. Slight modifications to the improved cloud-infrastructure deployment method can render the method a continuous process or service that can continuously accept new cloud templates and deploy the described cloud infrastructures in the new cloud templates while previously received cloud templates are being processed for deployment of the specified infrastructures. Prioritization of the cloud templates facilitates efficient allocation of network resources, as does identification and the reservation of a network profile along with a selected set of networks described in the network profile based on properties and tags associated with the network profile, networks contained in the network profile, and address ranges associated with the networks. This is facilitated by the addition of address-range tags, discussed above with reference to FIG. 25.

The present invention has been described in terms of particular embodiments, it is not intended that the invention be limited to these embodiments. Modifications within the spirit of the invention will be apparent to those skilled in the art. For example, any of many different implementations of the cloud-infrastructure-deployment methods and systems can be obtained by varying various design and implementation parameters, including modular organization, control structures, data structures, hardware, operating system, and virtualization layers, and other such design and implementation parameters.

What is claimed is:

1. A cloud-infrastructure-management service comprising:
one or more computer systems, each containing one or more processors, one or more memories, and one or more data-storage devices; and
processor instructions, stored in one or more of the one or more memories that, when executed by one or more of the one or more processors, control the one or more computer systems to implement the cloud-infrastructure-management service, the cloud-infrastructure-management service deploying cloud infrastructure specified in multiple cloud templates to cloud-provider cloud-computing facilities by
receiving multiple cloud templates associated with a cloud-infrastructure-deployment request,
ordering the multiple cloud templates by priorities associated with the cloud templates into an ordered set of cloud templates, and
for each cloud template, selected in descending priority order from the ordered set of cloud templates,
selecting a cloud-computing facility of a cloud provider to which to deploy the cloud infrastructure by matching computational-resource requirements and constraints specified in the cloud template to capabilities and characteristics of computational resources represented in stored representations of computational resources available in the cloud-computing facility, including capabilities and characteristics of networks and network address ranges,
reserving the stored descriptions,
allocating computational resources based on the reserved stored descriptions, and
provisioning the allocated computational resources by accessing a cloud-provider management interface.

2. The cloud-infrastructure-management service of claim 1 wherein the stored descriptions of the computational resources available in the cloud-computing facility include:
project data structures that each stores data that represents projects associated with cloud-infrastructure deployments, the project data structures including project properties, tags, and deployment policies;
cloud-zone data structures that each stores representations of computational resources available on a cloud-computing facility, the cloud-zone data structures including cloud-zone properties, tags, and deployment policies and the representations of computational resources each associates with properties and tags; and
network-policy data structures that each stores representations of network resources available on a cloud-computing facility, the network-policy data structures including network-policy properties, tags, and policies and the representations of network resources available on a cloud-computing facility including network properties, tags, and one or more network address ranges, each network address range representing one or more network addresses and including address-range properties and tags.

3. The cloud-infrastructure-management service of claim 2 wherein
a policy data structure may reference one or more cloud-zone data structures and one or more network-policy data structures;
a cloud-zone data structure is associated with a particular cloud provider and cloud-provider region comprising a cloud-computing facility or virtual data center; and
a network-profile data structure is associated with a particular cloud provider and cloud-provider region comprising a cloud-computing facility or virtual data center.

4. The cloud-infrastructure-management service of claim 3 wherein a cloud template includes:
a name and/or identifier;
a reference to a project data structure; and
representations of computational and network resources that need to be provisioned from a cloud-computing facility or virtual data center, each representation of a computational resource and each representation of a network resource including one or more properties and/or tags.

5. The cloud-infrastructure-management service of claim 4 wherein the cloud-infrastructure management service selects a cloud-computing facility of a cloud provider to which to deploy the cloud infrastructure by selecting network resources from a network-profile data structure that references the cloud-computing facility or virtual data center and by selecting computational resources from the cloud-zone data structure that also references the cloud-computing facility or virtual data center.

6. The cloud-infrastructure-management service of claim 5 wherein the cloud-infrastructure management service selects network resources from the network-profile data structure by:
matching the properties and/or tags of each network resource specified in the cloud template to properties and/or tags of a network-profile data structure;
matching the properties and/or tags of each network resource specified in the cloud template to properties and/or tags of one or more network representations within the network-profile data structure; and
matching the properties and/or tags of each network resource specified in the cloud template to properties and/or tags of one or more address ranges in the one or more network representations.

7. The cloud-infrastructure-management service of claim 5 wherein the cloud-infrastructure management service selects computational resources from the cloud-zone data structure by:
matching the properties and/or tags of each computational resource specified in the cloud template to properties and/or tags of the cloud-zone data structure; and
by matching the properties and/or tags of each computational resource specified in the cloud template to properties and/or tags of a computational-resource representation in the cloud-zone data structure.

8. The cloud-infrastructure-management service of claim 5 wherein the cloud-infrastructure management service selects the network-profile data structure and the cloud-zone data structure by determining that the cloud-infrastructure deployment specified in the cloud template is compatible with any deployment policies contained in the network-profile data structure and the cloud-zone data structure.

9. The cloud-infrastructure-management service of claim 1 wherein the priority associated with a cloud template is stored in the project data structures referenced by the cloud template.

10. The cloud-infrastructure-management service of claim 1 wherein the cloud-infrastructure-management service returns a success response to a cloud-infrastructure-deployment request for each cloud template specifying cloud infrastructure successfully provisioned within a cloud-computing facility or virtual data center and returns a failure response to the cloud-infrastructure-deployment request for each cloud template specifying cloud infrastructure that was not provisioned within a cloud-computing facility or virtual data center as a result of a failure to select a network-profile data structure and cloud-zone data structure compatible with the cloud infrastructure specified by the cloud template.

11. A method that deploys cloud infrastructure in a computing facility or virtual data center in response to a cloud-infrastructure-deployment request, the method comprising:
receiving multiple cloud templates associated with a cloud-infrastructure-deployment request;
ordering the multiple cloud templates by priorities associated with the cloud templates into an ordered set of cloud templates; and
for each cloud template, selected in descending priority order from the ordered set of cloud templates,
selecting a cloud-computing facility of a cloud provider to which to deploy the cloud infrastructure by matching computational-resource requirements and constraints specified in the cloud template to capabilities and characteristics of computational resources represented in stored representations of computational resources available in the cloud-computing facility, including capabilities and characteristics of networks and network address ranges,
reserving the stored descriptions,
allocating computational resources based on the reserved stored descriptions, and
provisioning the allocated computational resources by accessing a cloud-provider management interface.

12. The method of claim 11 wherein the stored descriptions of the computational resources available in the cloud-computing facility include:
project data structures that each stores data that represents projects associated with cloud-infrastructure deployments, the project data structures including project properties, tags, and deployment policies;
cloud-zone data structures that each stores representations of computational resources available on a cloud-computing facility, the cloud-zone data structures including cloud-zone properties, tags, and deployment policies and the representations of computational resources each associates with properties and tags; and
network-policy data structures that each stores representations of network resources available on a cloud-computing facility, the network-policy data structures including network-policy properties, tags, and policies and the representations of network resources available on a cloud-computing facility including network properties, tags, and one or more network address ranges, each network address range representing one or more network addresses and including address-range properties and tags.

13. The method of claim 12 wherein
a policy data structure may reference one or more cloud-zone data structures and one or more network-policy data structures;
a cloud-zone data structure is associated with a particular cloud provider and cloud-provider region comprising a cloud-computing facility or virtual data center; and
a network-profile data structure is associated with a particular cloud provider and cloud-provider region comprising a cloud-computing facility or virtual data center.

14. The method of claim 13 wherein a cloud template includes:
a name and/or identifier;
a reference to a project data structure; and
representations of computational and network resources that need to be provisioned from a cloud-computing facility or virtual data center, each representation of a computational resource and each representation of a network resource including one or more properties and/or tags.

15. The method of claim 14 wherein the cloud-infrastructure management service selects a cloud-computing facility of a cloud provider to which to deploy the cloud infrastructure by selecting network resources from a network-profile data structure that references the cloud-computing facility or virtual data center and by selecting computational resources from the cloud-zone data structure that also references the cloud-computing facility or virtual data center.

16. The method of claim 15 wherein the cloud-infrastructure management service selects network resources from the network-profile data structure by:
matching the properties and/or tags of each network resource specified in the cloud template to properties and/or tags of a network-profile data structure;
matching the properties and/or tags of each network resource specified in the cloud template to properties and/or tags of one or more network representations within the network-profile data structure; and
matching the properties and/or tags of each network resource specified in the cloud template to properties and/or tags of one or more address ranges in the one or more network representations.

17. The method of claim 15 wherein the cloud-infrastructure management service selects computational resources from the cloud-zone data structure by:
matching the properties and/or tags of each computational resource specified in the cloud template to properties and/or tags of the cloud-zone data structure; and
by matching the properties and/or tags of each computational resource specified in the cloud template to properties and/or tags of a computational-resource representation in the cloud-zone data structure.

18. The method of claim 15 wherein the cloud-infrastructure management service selects the network-profile data structure and the cloud-zone data structure by determining that the cloud-infrastructure deployment specified in the cloud template is compatible with any deployment policies contained in the network-profile data structure and the cloud-zone data structure.

19. The method of claim 11 wherein the priority associated with a cloud template is stored in the project data structures referenced by the cloud template.

20. A physical data-storage device encoded with processor instructions that, when executed by one or more processors within one or more computer systems, each containing one or more processors, one or more memories, and one or more data-storage devices, control the one or more computer systems to implement a cloud-infrastructure-management service that deploys cloud infrastructure in a computing facility or virtual data center in response to a cloud-infrastructure-deployment request by:
receiving multiple cloud templates associated with a cloud-infrastructure-deployment request;
ordering the multiple cloud templates by priorities associated with the cloud templates into an ordered set of cloud templates; and
for each cloud template, selected in descending priority order from the ordered set of cloud templates,
selecting a cloud-computing facility of a cloud provider to which to deploy the cloud infrastructure by matching computational-resource requirements and constraints specified in the cloud template to capabilities and characteristics of computational resources represented in stored representations of computational resources available in the cloud-computing facility, including capabilities and characteristics of networks and network address ranges,
reserving the stored descriptions,
allocating computational resources based on the reserved stored descriptions, and
provisioning the allocated computational resources by accessing a cloud-provider management interface.
